(19) United States
(12) Patent Application Publication
(10) Pub. No.: US 2016/0176206 A1
(43) Pub. Date: Jun. 23, 2016

(54) PRINTING APPARATUS, PRINTING SYSTEM, AND CORRECTION VALUE CALCULATION METHOD

(71) Applicant: Seiko Epson Corporation, Tokyo (JP)

(72) Inventor: Ayako KOBAYASHI, Okaya (JP)

(21) Appl. No.: 14/963,669

(22) Filed: Dec. 9, 2015

(30) Foreign Application Priority Data
Dec. 19, 2014 (JP) 2014-256997

(51) Int. Cl. B41J 13/00

(52) U.S. Cl. CPC B41J 13/0009

(57) ABSTRACT

A printer includes a transport roller which transports a paper sheet, a head which is able to discharge liquid droplets, and a controller which controls the transport roller and the head, in which a plurality of patches are printed using the head in the transport direction of the paper sheet within a range of one circumference length of the transport roller, and information which relates to discharge of the liquid droplets is corrected based on information which is obtained from the plurality of patches.

### BACKGROUND

1. Technical Field

The present invention relates to a printing apparatus, a printing system which is provided with the printing apparatus, and a correction value calculation method.

2. Related Art

In the related art, an ink jet printer is known, which prints an image by discharging ink onto a front surface of a medium such as paper or cloth. In the ink jet printer, a transport operation which causes the medium to move in a transport direction using a transport roller and a dot forming operation in which ink is discharged while a head on which a plurality of nozzles are formed is moved in a scanning direction which intersects with the transport direction of the medium are alternately repeated, a dot row that is formed of dots along the scanning direction is formed lined up in the transport direction, and an image is formed on the medium (JP-A-2006-305962).

In the ink jet printer described in JP-A-2006-305962, in a case where, for example, process accuracy of the nozzle is poor, and there is variation in the amount of ink discharged from the nozzle, there is a concern that concentration unevenness (color unevenness) is generated in the image which is formed on the medium. For this reason, in a manufacturing plant of the printer, a correction pattern is printed by the manufactured printer, a concentration unevenness correction value is calculated from color information which is obtained due to colorimetry on the correction pattern, the concentration unevenness correction value is registered in the printer, and an ink discharge state of the nozzle is corrected in each printer machine.

Furthermore, when the transport roller is biased, that is, a distance between a center of rotation of the transport roller and an outer periphery of the transport roller varies, in a case where the medium is transported by causing the transport roller to rotate once, a portion where the medium is quickly transported and a portion where the medium is slowly transported are generated. For this reason, in the portion where the medium is quickly transported and the portion where the medium is slowly transported, the concentrations of the printed images (dot state) are different. Consequently, the correction pattern is printed, which is equivalent to the amount of transport of one rotation of the transport roller, and the concentration unevenness correction value is calculated by reading (carrying out colorimetry on) both the correction pattern of the portion where the medium is quickly transported and the correction pattern of the portion where the medium is slowly transported. In detail, the amount of transport of one rotation of the transport roller is approximately one inch (25.4 mm), and the correction pattern of a length of approximately one inch is printed in the transport direction.

Meanwhile, in the ink jet printer, it is desirable to print a higher quality image at a higher speed.

When the type and colorimetry conditions of the ink which is used in order to print the higher quality image are increased, it is necessary to print the correction pattern more greatly. In order to print the higher quality image, when the correction pattern of the length of the amount of transport of one rotation of the transport roller is formed (printed) more greatly, there is a problem in that the number of processes for printing the correction pattern and the number of process for carrying out colorimetry on the correction pattern are increased, and the workability for calculating the concentration unevenness correction value is worsened.

### SUMMARY

The invention can be realized in the following aspects or application examples.

### APPLICATION EXAMPLE 1

According to this application example, there is provided a printing apparatus including a transport roller which transports a medium, a head which is able to discharge liquid droplets, and a control section which controls the transport roller and the head, in which a plurality of patterns are printed using the head in a transport direction of the medium within a range of one circumference length of the transport roller, and information which relates to discharge of the liquid droplets is corrected based on information which is obtained from the plurality of patterns.

Since the plurality of patterns (available patterns of a plurality of sets of information) are printed in the range of one circumference length of the transport roller, it is possible to acquire a greater amount of information by carrying out colorimetry (reading) on the pattern which is provided within the range of one circumference length of the transport roller in comparison to a case in which the pattern of one circumference length of the transport roller (available patterns of a single set of information) is printed. That is, it is possible to efficiently acquire a great amount of information in which the discharge of liquid droplets is corrected.

### APPLICATION EXAMPLE 2

In the printing apparatus according to the application example, the plurality of patterns preferably include a plurality of first patterns, and a plurality of second patterns which have information that is different from the plurality of first patterns.

Since the plurality of patterns include the plurality of first patterns, and the plurality of second patterns which have information that is different from the plurality of first patterns, it is possible to efficiently acquire a greater amount of information and efficiently correct information which relates to discharge of liquid droplets in comparison to a case in which the plurality of patterns include only the plurality of first patterns.

### APPLICATION EXAMPLE 3

In the printing apparatus according to the application example, a color of the plurality of second patterns is preferably different from a color of the plurality of first patterns.

Since the plurality of patterns include the plurality of first patterns, and the plurality of second patterns which have color that is different from the plurality of first patterns, it is possible to efficiently acquire information which relates to a greater amount of colors and efficiently perform correction which is related to discharge of liquid droplets of a greater amount of colors in comparison to a case in which the plurality of patterns include only the plurality of first patterns.

### APPLICATION EXAMPLE 4

In the printing apparatus according to the application example, a size of the liquid droplets which are discharged from the head is preferably different in the plurality of first patterns and the plurality of second patterns.

The plurality of patterns includes the plurality of first patterns and the plurality of second patterns with a size of a dot which is different from a size of a dot which configures the plurality of first patterns. Accordingly, it is possible to efficiently acquire information which relates to various sizes of dots and efficiently carry out correction of various sizes of dots (correction of the liquid droplets which correspond to the various sizes of dots) in comparison to a case in which the plurality of patterns include only the plurality of first patterns.

### APPLICATION EXAMPLE 5

In the printing apparatus according to the application example, preferably, a reading unit that is able to read the plurality of patterns is further included.

Since the printing apparatus includes the reading unit that is able to read the plurality of patterns, it is possible to periodically read the plurality of patterns which are printed by the printing apparatus, and periodically correct information which relates to discharge of the liquid droplets. For example, even in a case where the discharge state of the liquid droplets of the printing apparatus is changed over time, it is possible to maintain an optimal liquid droplet discharge state.

### APPLICATION EXAMPLE 6

According to this application example, there is provided a printing system which includes the printing apparatus described in the application examples and a computer which controls the printing apparatus.

Since the printing apparatus described in the application examples includes a plurality of acquirable patterns of a variety of information within a range of one circumference length of the transport roller, it is possible to more efficiently correct information which relates to discharge of the liquid droplets in comparison to a case of including the pattern of the one circumference length of the transport roller (acquirable patterns of a single set of information). Accordingly, in the printing system which includes the printing apparatus described in application example, it is also possible to further efficiently correct information which relates to discharge of the liquid droplets.

### APPLICATION EXAMPLE 7

According to this application example, there is provided a correction value calculation method of a printing apparatus including a transport roller that transports a medium and a head that is able to discharge liquid droplets, in which correction of discharge of the liquid droplets is carried out, the method including printing a plurality of patterns on the medium within a range of one circumference length of the transport roller in a transport direction of the medium, and calculating a correction value based on information that is obtained from the plurality of patterns.

For example, in a case where patterns of a greater amount of colors are printed and colorimetry is carried out in order to print an image more quickly, or in a case where the transport roller is increased in size in order to print the higher quality image, since the plurality of patterns (patterns of various colors) are formed within a range of one circumference length of the transport roller, a number of processes for printing the patterns or the number of processes for carrying out colorimetry (reading) on the patterns are reduced in comparison to a case where the patterns of one circumference length of the transport roller are respectively formed in the various colors. Accordingly, it is possible to more efficiently carry out colorimetry (reading) on the plurality of patterns, and more efficiently calculate the correction value in which information that relates to discharge of the liquid droplets is corrected.

### BRIEF DESCRIPTION OF THE DRAWINGS

The invention will be described with reference to the accompanying drawings, wherein like numbers reference like elements.

FIG. 1 is a block diagram illustrating the entire configuration of a printing system according to Embodiment 1.

FIG. 2A is a schematic view illustrating the entire configuration of a printer according to Embodiment 1, and FIG. 2B is a cross-sectional view of the printer.

FIG. 3 is an explanatory diagram illustrating a nozzle arrangement.

FIG. 4 is an explanatory diagram of a virtual head set.

FIG. 5 is an explanatory diagram of a normal process.

FIG. 6 is an explanatory diagram of dot formation in a region A and a region B of FIG. 5.

FIG. 7A is a schematic diagram illustrating a state of a dot which is ideally formed in single color printing, FIG. 7B is a schematic diagram illustrating a state of a dot which is formed in single color printing prior to correction, and FIG. 7C is a schematic diagram illustrating a state of a dot which is formed in single color printing after correction.

FIG. 8 is a flow chart of a process in which a color unevenness correction value is acquired, which is performed at a manufacturing plant side of the printer.

FIG. 9 is a flow chart of a process during printing which is performed at a user side.

FIG. 10 is a block view of a printing data generation process.

FIG. 11 is a table illustrating formation conditions of patches which includes a test pattern includes.

FIG. 12 is a graph illustrating a relationship of color difference of printed images and a patch area for acquiring color information.

FIG. 13 is a schematic diagram of a test pattern according to Embodiment 1.

FIG. 14 is a schematic diagram of a test pattern according to Modification Example 1.

FIG. 15 is a schematic diagram of a test pattern according to Modification Example 2.

FIG. 16 is a schematic diagram of a test pattern according to Modification Example 3.

FIG. 17 is a block diagram illustrating the entire configuration of a printing system according to Embodiment 2.

FIG. 18 is a schematic view illustrating the entire configuration of a printer according to Embodiment 2.

FIG. 19 is a schematic diagram of a test pattern according to known technologies.

### DESCRIPTION OF EXEMPLARY EMBODIMENTS

Embodiments of the invention will be described with reference to the drawings. The present embodiment illustrates an aspect of the invention, but is not limited to the invention, and is able to be arbitrarily modified within the scope of the technical concept of the present application. In addition, in each of the following drawings the dimensions are drawn to be different to the actual dimensions in order for the description to be easy to understand.

### Embodiment 1

### Printing System Summary

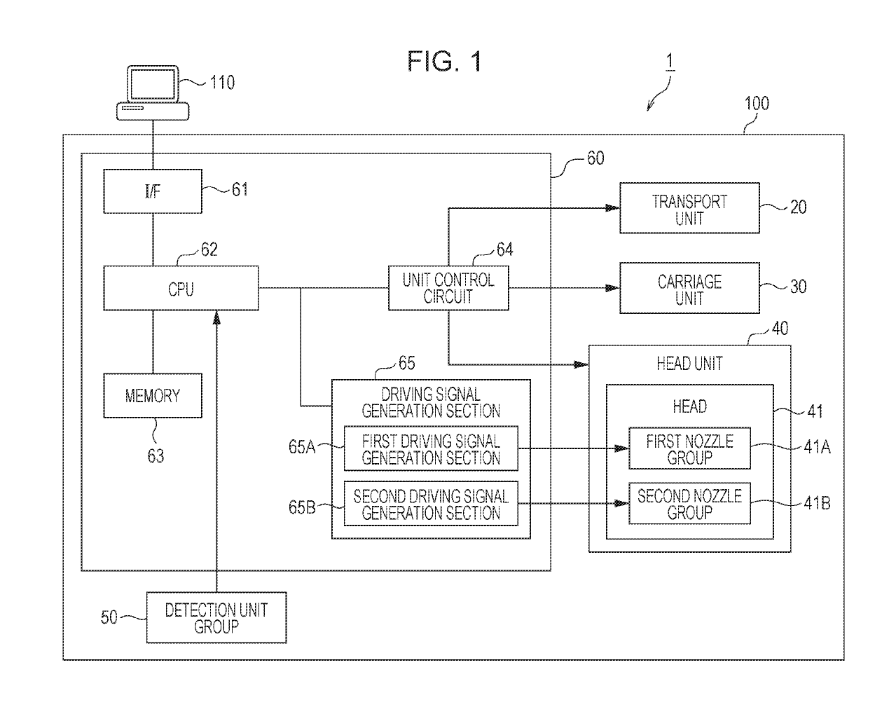

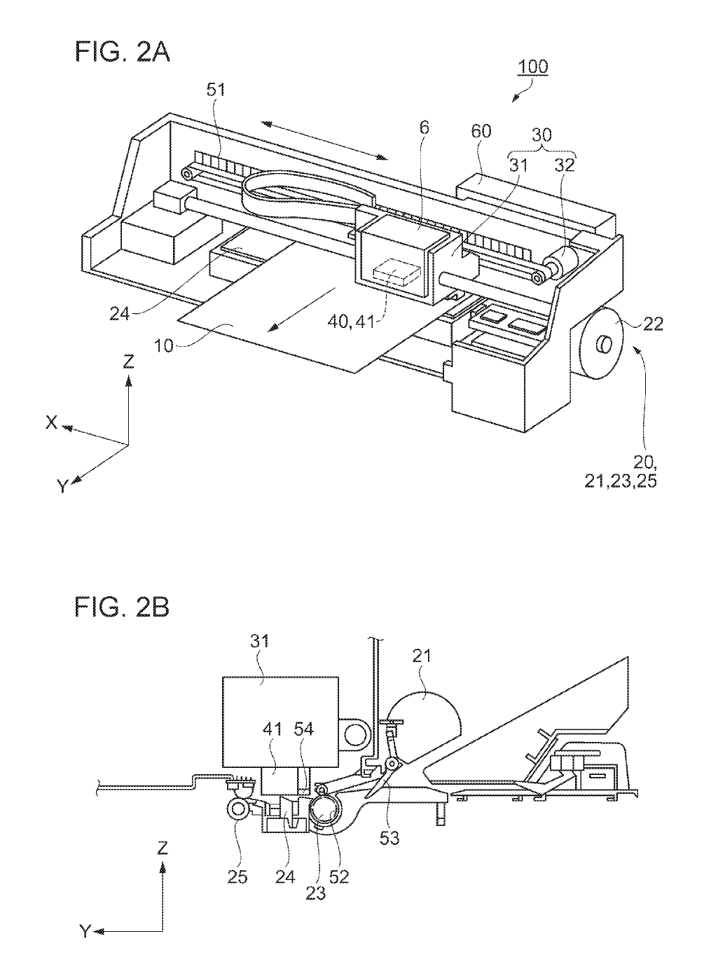

FIG. 1 is a block diagram illustrating the entire configuration of a printing system according to Embodiment 1. FIG. 2A is a schematic view illustrating the entire configuration of an ink jet printer (hereinafter, referred to as printer) according to the embodiment. FIG. 2B is a cross-sectional view of the printer according to the embodiment.

A summary of a printing system 1 will be described with reference to FIG. 1 and FIGS. 2A and 2B.

As shown in FIG. 1, the printing system 1 is configured by a printer 100 which is an example of a “printing apparatus” and a computer 110 (hereinafter, referred to as PC 110).

The PC 110 is communicably connected to the printer 100, and printing data according to an image is output to the printer 100. A computer program such as an application program and a printer driver is installed in the PC 110.

The printer 100 is a printing apparatus which prints a predetermined image based on printing data which is output from the PC 110.

As shown in FIG. 1 and FIGS. 2A and 2B, the printer 100 has a transport unit 20, a carriage unit 30, a head unit 40, a detection unit group 50, and a controller 60. The printer 100, which receives the printer data (image formation data) from the PC 110, controls each unit (the transport unit 20, the carriage unit 30, and the head unit 40) using the controller 60, and an image is printed on a paper sheet 10 which is an example of the “medium”. A situation inside the printer 100 is monitored by the detection unit group 50, and the detection unit group 50 outputs a detection result to the controller 60.

Hereinafter in the description, a direction in which the paper sheet 10 is transported (discharged) is a Y direction, a direction in which the carriage unit 30 is moved which intersects with the Y direction is an X direction, and a direction which is orthogonal to the X direction and the Y direction is a Z direction. In addition, a leading end side of an arrow which illustrates a direction in the drawings is a “(+) direction” and a base end side is a “(−) direction”.

The transport unit 20 has a function of causing the paper sheet 10 to move in the transport direction (Y direction). The transport unit 20 is provided with a paper feeding roller 21, a transport motor 22, a transport roller 23, a platen 24, and a discharge roller 25. The paper feeding roller 21 feeds the paper sheet 10 which is inserted from the rear surface of the printer 100 (Y(−) direction) inside the printer 100. The transport roller 23 transports the fed paper sheet 10 using the paper feeding roller 21 to a region in which printing is possible in an upper section of the platen 24. The platen 24 supports the paper sheet 10 during printing. The discharge roller 25 discharges the paper sheet 10 to the front surface of the printer 100 (in the transport direction). The paper feeding roller 21, the transport roller 23, and the discharge roller 25 are driven by the transport motor 22.

The carriage unit 30 has a function of causing a head 41 which will be described later to reciprocally move (scan) in a predetermined direction (the X direction, hereinafter referred to as a scanning direction). The carriage unit 30 is provided with a carriage 31, a carriage motor 32, and the like. The carriage 31 is able to reciprocally move in the scanning direction, and is driven by the carriage motor 32. In addition, the carriage 31 holds an ink cartridge 6, which accommodates ink, so as to be attachable and detachable.

The head unit 40 has a function of discharging ink onto the paper sheet 10 as liquid droplets (hereinafter, referred to as ink droplets). The head unit 40 is provided with a head 41 which has a plurality of nozzles (nozzle rows). The head 41 is mounted on the carriage 31, and moves in the scanning direction. A dot row (raster line) is formed (printed) on the paper sheet 10 along the scanning direction by the ink droplets being discharged while the head 41 is caused to move in the scanning direction.

The head 41 is provided with two heads (first nozzle group 41A, second nozzle group 41B). The configuration of the head 41 will be described later.

The detection unit group 50 has a linear encoder 51, a rotary encoder 52, a paper detection sensor 53, an optical sensor 54, and the like. The linear encoder 51 detects a position of the carriage 31 in a movement direction. The rotary encoder 52 detects an amount of rotation of the transport roller 23. The paper detection sensor 53 detects a position of a leading end of the paper sheet 10 during paper feeding. An optical sensor 54 detects presence or absence of the paper sheet 10 using a light emitting section and a light receiving section which are attached to the carriage 31. The optical sensor 54 is able to detect the position of the end section of the paper sheet 10 while being moved by the carriage 31, and detect a width of the paper sheet 10. The optical sensor 54 is able to detect the leading end (leading section on the transport direction downstream side) and the rear end (end section on the transport direction upstream side) of the paper sheet 10 according to the situation.

The controller 60 is a control section which controls the entirety of the printer 100. The controller 60 is provided with an interface section 61, a CPU 62, a memory 63, a unit control circuit 64, and the like. The interface section 61 performs data transfer and reception between the PC 110 and the printer 100. The CPU 62 is an arithmetic processing apparatus for performing control of the entirety of the printer 100. The memory 63 is a storage medium which secures a region in which a program that is operated by the CPU 62 is stored, an operated work region, and the like, and is configured by a memory element such as a RAM, and an EEPROM.

The CPU 62 controls each unit (the transport unit 20, the carriage unit 30, and the head unit 40) via the unit control circuit 64 according to the program which is stored in the memory 63.

Furthermore, a driving signal generation section 65 is provided to the controller 60. The driving signal generation section 65 is provided with a first driving signal generation section 65A and a second driving signal generation section 65B. The first driving signal generation section 65A generates a first driving signal for driving a piezo element of the first nozzle group 41A. The second driving signal generation section 65B generates a second driving signal for driving a piezo element of the second nozzle group 41B. Each driving signal generation section generates a driving signal for odd-numbered pixels in a case where dots are formed in odd-numbered pixels which will be described later, and generates a driving signal for even-numbered pixels in a case where dots are formed in even-numbered pixels which will be described later. Each driving signal generation section is independent from each other, and for example, when the first driving signal generation section 65A generates the driving signal for odd-numbered pixels, the second driving signal generation section 65B is able to generate the driving signal for odd-numbered pixels and is also able to generate the driving signal for even-numbered pixels.

The printer 100 alternately repeats a liquid droplet discharge operation in which ink is discharged by the head 41 as the liquid droplets and a transport operation in which the paper sheet 10 is transported by the transport roller 23 in a transport direction, and prints an image which is configured from a plurality of dots on the paper sheet 10. That is, a predetermined image is printed on the paper sheet 10 by lining up a dot row (raster line) along a scanning direction in the transport direction. Here, the liquid droplet discharge operation is referred to as a “pass”, and an n^{th} pass is referred to as “pass n”.

### Head Configuration

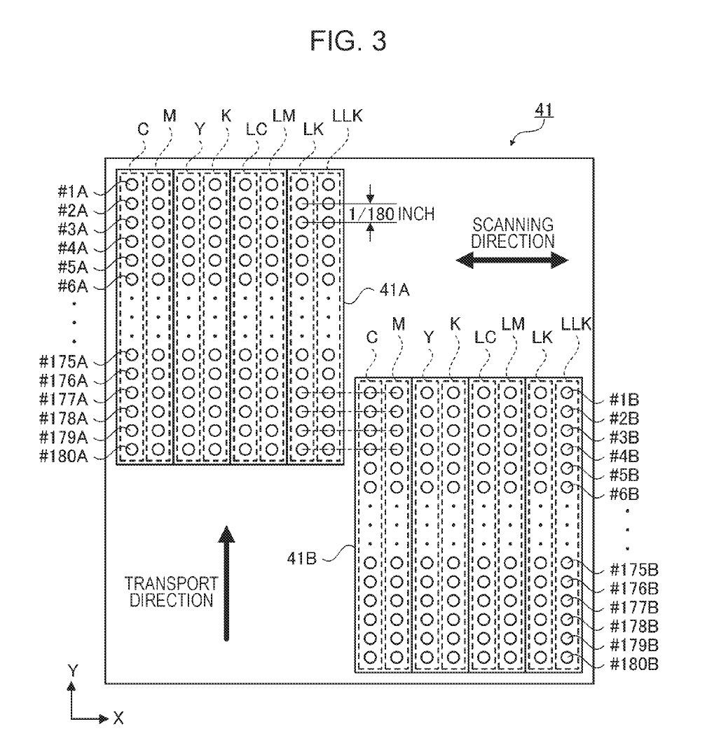

FIG. 3 is an explanatory diagram illustrating a nozzle arrangement.

As shown in FIG. 3, the head 41 is provided with two heads (nozzle groups), that is, the first nozzle group 41A and the second nozzle group 41B. Eight nozzle rows are respectively provided in the nozzle groups 41A and 41B. Discharge openings (openings) of the nozzles are provided on the lower surface of the head 41 (the surface on the Z(−) direction side in FIGS. 2A and 2B). Eight nozzle rows respectively discharge ink of cyan (C), magenta (M), yellow (Y), black (K), light cyan (LC), light magenta (LM), light black (LK), and very light black (LLK).

180 nozzles (nozzle #1A to #180A, nozzle #1B to #180B) which are lined up in the transport direction are provided in respective nozzle rows at a pitch of 180 dpi. In FIG. 3, numbers are given in the order of the nozzles on the transport direction downstream side (Y(+) direction side). A piezo element (which is omitted from the drawings) is provided in the respective nozzles as a driving element for discharging ink droplets from the respective nozzles.

The first nozzle group 41A is provided more on the downstream side in the transport direction than the second nozzle group 41B. In addition, the first nozzle group 41A and the second nozzle group 41B are provided such that the positions of four nozzles in the transport direction do not overlap. That is, nozzle #177A of the first nozzle group 41A, nozzle #1B of the second nozzle group 41B, nozzle #178A of the first nozzle group 41A and nozzle #2B of the second nozzle group 41B, nozzle #179A of the first nozzle group 41A and nozzle #3B of the second nozzle group 41B, and nozzle #180A of the first nozzle group 41A and nozzle #4B of the second nozzle group 41B are respectively provided such that the positions in the transport direction do not overlap. For example, in the liquid droplet discharge operation, when it is possible for nozzle #177A of the first nozzle group 41A to form a dot with respect to a pixel, it is also possible for nozzle #1B of the second nozzle group 41B to form a dot with respect to the pixel.

In addition, a combination of nozzle rows which discharge the same ink (ink which is configured with the same composition) between the first nozzle group 41A and the second nozzle group 41B is referred to as a “head set”.

### Nozzle Row and Nozzle Representation Method

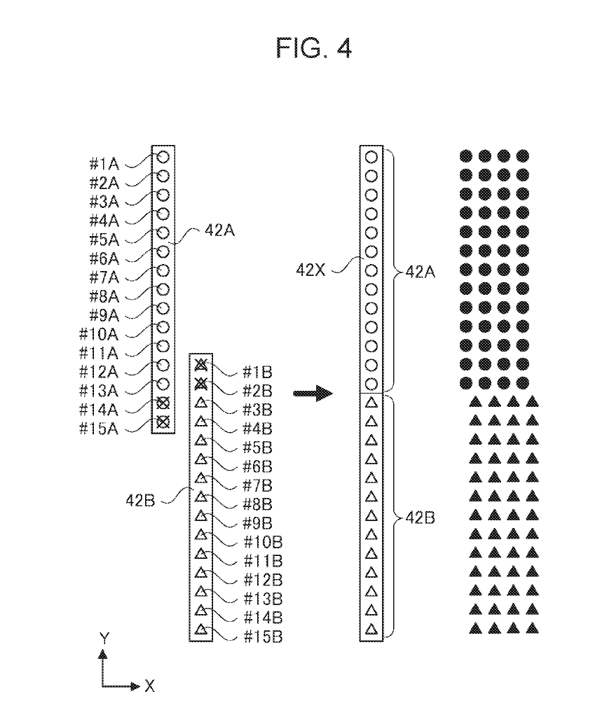

FIG. 4 is an explanatory diagram of a virtual head set. The nozzle rows and a representation method of the nozzles will be described with reference to FIG. 4.

The black K nozzle row of the first nozzle group 41A and the black K nozzle row of the second nozzle group 41B are illustrated on the left side in FIG. 4. Hereinafter in the description, the black K nozzle row of the first nozzle group 41A is referred to as a first head 42A, and the black nozzle row of the second nozzle group 41B is referred to as a second head 42B. Here, in order to simplify the description, the number of nozzles in each nozzle row is 15.

The positions in the transport direction of the four nozzles (nozzle #12A to nozzle #15A) on the upstream side of the first head 42A in the transport direction, and the four nozzles (nozzle #1B to nozzle #4B) on the downstream side of the second head 42B in the transport direction overlap. Hereinafter, the four nozzles where the positions overlap in the transport direction are referred to as overlapping nozzles.

In addition, in FIG. 4, each nozzle of the first head 42A is illustrated with a circle, and each nozzle of the second head 42B is illustrated with a triangle. Furthermore, a cross is given for nozzles which do not discharge ink (that is, nozzles which do not form a dot).

Here, out of the overlapping nozzles of the first head 42A, nozzle #12A and nozzle #13A discharge ink, and nozzle #14A and nozzle #15A do not discharge ink. In addition, out of the overlapping nozzles of the second head 42B, nozzle #1B and nozzle #2B do not discharge ink, and nozzle #3B and nozzle #4B discharge ink.

In this case, as exemplified in the center section in FIG. 4, two heads (the first head 42A and the second head 42B) which configure the head set are able to be represented as one virtual head set 42X. Hereinafter in the description, the state of dot formation is described using the one virtual head set 42X in place of the two heads which are separately drawn.

As shown on the right side in FIG. 4, in the virtual head set 42X, even when the circle nozzles form dots in odd-numbered pixels, it is possible for the triangle nozzles to form dots in the even-numbered pixels. Of course, when the circle nozzles form dots in the odd-numbered pixels, it is also possible for the triangle nozzles to form dots in the odd-numbered pixels.

### Normal Process Dot Formation Method

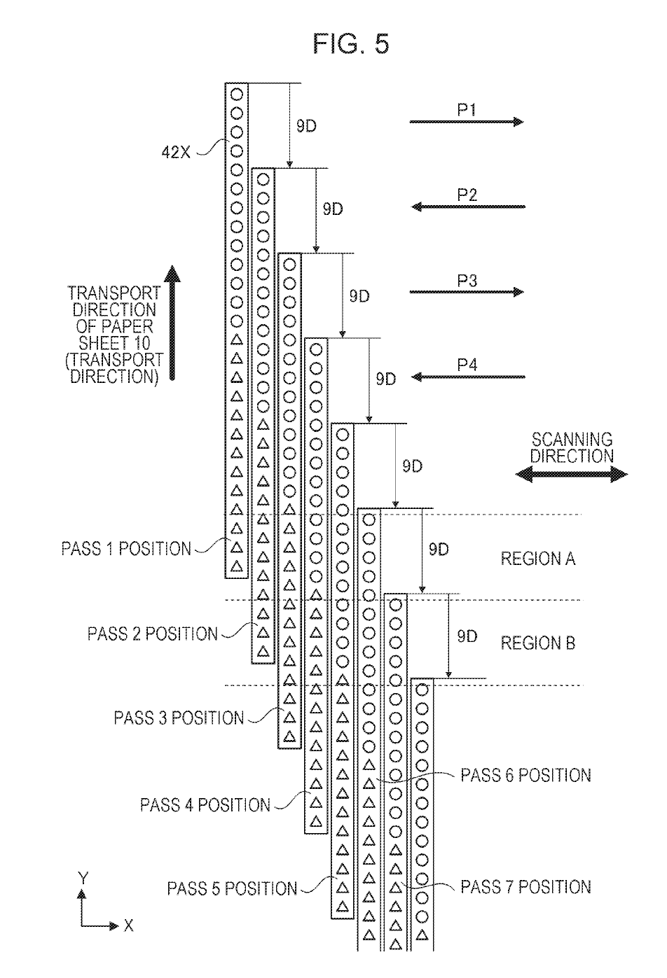

FIG. 5 is an explanatory diagram of a normal process. The normal process is a process (the liquid droplet discharge operation and the transport operation) which is performed when the center section of the paper sheet 10 (a region which is neither the upper end section nor the lower end section of the paper sheet 10) is printed. By the controller 60 controlling each unit, the normal process which is described below is realized.

In FIG. 5, a relative positional relationship of the virtual head set 42X is illustrated with respect to the paper sheet 10 in the liquid droplet discharge operation.

Arrows P1 to P4 in FIG. 5 illustrate a direction in which the virtual head set 42X is scanned. Furthermore, although the virtual head set 42X is drawn so as to move with respect to the paper sheet 10, in practice, the paper sheet 10 moves in the transport direction. In addition, in FIG. 5, the positional relationship of the virtual head set 42X in the X(+) direction does not have significance.

As shown in FIG. 5, in the normal process, the paper sheet 10 is transported at an amount of transport 9D of nine dots in the transport operation which is performed between passes. For example, dots are formed by pass 1 to pass 6 in the region A (a region above the paper sheet 10). Dots are formed by pass 2 to pass 7 in the region B.

In an odd-numbered pass, for example, each nozzle is positioned on an odd-numbered raster line (dot row along the scanning direction). After the odd-numbered pass, since an even-numbered pass is performed after the paper sheet 10 is transported at the amount of transport 9D of nine dots, in the even-numbered pass, each nozzle is positioned on the even-numbered raster line. In this manner, the position of each nozzle is a position of the odd-numbered or even-numbered raster line alternately by pass.

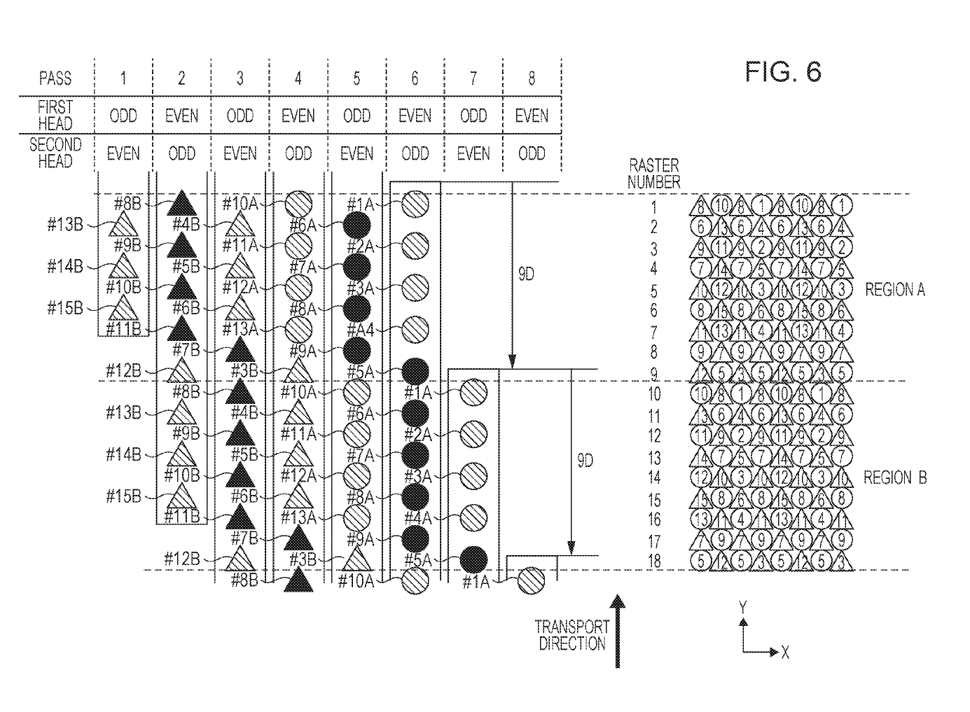

FIG. 6 is an explanatory diagram of dot formation in the region A and the region B in FIG. 5.

The relative position of the nozzles in each pass is illustrated on the left side in FIG. 6. In the pass, a nozzle filled with black forms a dot at a proportion of one pixel to two pixels. For example, the nozzle #8B of pass 2 forms a dot at a proportion of one pixel to two pixels. The nozzles which are hatched with diagonal lines form a dot at a proportion of one pixel to four pixels. For example, the nozzle #10A of pass 4 forms a dot at a proportion of one pixel to four pixels.

The nozzles which are hatched with diagonal lines form only a half dot in comparison to the nozzle filled in with black. Hereinafter, the nozzles which are hatched with diagonal lines will be referred to as partial overlap nozzles.

Four nozzles (nozzle #10A to nozzle #13A) on the upstream side (−Y direction side) of the first head 42A of a pass in the transport direction, and four nozzles (nozzle #1A to nozzle #4A) on the downstream side (+Y side) of the first head 42A in the transport direction after the transport operation is performed two times from the pass overlap at positions in the transport direction. Such nozzles are partial overlap nozzles. For example, since nozzle #10A to nozzle #13A of pass 4 and nozzle #1A to nozzle #4A of pass 6 overlap at positions in the transport direction, the nozzles are partial overlap nozzles.

In the same manner, four nozzles (nozzle #12B to nozzle #15B) on the upstream side of the second head 42B of a pass in the transport direction, and four nozzles (nozzle #3B to nozzle #6B) on the downstream side of the second head 42B in the transport direction after the transport operation is performed two times from the pass overlap at positions in the transport direction. Such nozzles are partial overlap nozzles. For example, since nozzle #12B to nozzle #15B of pass 2 and nozzle #3B to nozzle #6B of pass 4 overlap at positions in the transport direction, the nozzles are partial overlap nozzles.

The nozzles which form dots in the respective pixels are illustrated on the right side in FIG. 6. For example, a first raster line (the raster number of one line) is configured by dots which are formed in odd-numbered pixels by nozzle #8B and dots which are formed in even-numbered pixels by nozzle #10A and nozzle #1A. Here, in order to simplify the description, each raster line is configured by only eight dots.

The position of the dots which are formed by each head are illustrated in the top left in FIG. 6. For example, in pass 1, nozzles (nozzle #1A to nozzle #13A) of the first head 42A form dots in odd-numbered pixels, and nozzles (nozzle #3B to nozzle #15B) of the second head 42B form dots in even-numbered pixels.

Each raster line is configured from dots which are formed using two or three nozzles. In other words, two or three nozzles are associated with each raster line. For example, nozzle #8B of pass 2, nozzle #10A of pass 4, and nozzle #1A of pass 6 are associated with the first raster line. In addition, each raster line is configured from dots which are formed using at least one nozzle of the first head 42A, and dots which are formed using at least one nozzle of the second head 42B. In other words, at least one nozzle of the first head 42A and at least one nozzle of the second head 42B are associated with each raster line.

In a case where only one nozzle is associated with the odd-numbered pixel or the even-numbered pixel of the raster line, the nozzle forms a dot at a proportion of one pixel to two pixels. For example, nozzle#8B is associated with only one (another nozzle is not associated) odd-numbered pixel of the first raster line. For this reason, the nozzle #8B forms a dot at a proportion of one pixel to two pixels.

Meanwhile, in a case where two nozzles are associated with the odd-numbered pixel or the even-numbered pixel of the raster line, the two nozzles each form a dot at a proportion of one pixel to four pixels (become partial overlap nozzles). For example, nozzle #10A and nozzle #1A are associated with the even-numbered pixels of the first raster line. For this reason, nozzle #10A and nozzle #1A each form a dot at a proportion of one pixel to four pixels (become partial overlap nozzles).

In the normal process, in the pass, a position at which the first head 42A forms dots (position in the scanning direction) is different from a position at which the second head 42B forms dots. In detail, when the first head 42A forms dots in the odd-numbered pixels, the second head 42B forms dots in the even-numbered pixels. Alternatively, when the first head 42A forms dots in the even-numbered pixels, the second head 42B forms dots in the odd-numbered pixels. Since the first driving signal generation section 65A and the second driving signal generation section 65B described above are able to generate driving signals independently from each other, such dot formation is possible.

In addition, in the normal process, when comparing the pass and a subsequent pass, the positions at which each head forms dots are different. For example, in a case where the first head 42A forms the dots in the odd-numbered pixels and the second head 42B forms the dots in the even-numbered pixels in the pass, in the subsequent pass, the first head 42A forms the dots in the even-numbered pixels and the second head 42B forms the dots in the odd-numbered pixels.

By forming the dots in this manner, the dots are formed in a zig-zag shape by the one head, and the dots are formed in a zig-zag shape by the other head so as to fill between the zig-zag shape of the one head. When taking note of the right side in FIG. 6, the circle dots which are formed by the first head 42A are in the zig-zag shape, and the triangle dots which are formed by the second head 42B are also in the zig-zag shape. Here, from the dot forming order, after the dots which are formed by the second head 42B in the zig-zag shape, the dots which are formed by the first head 42A are formed so as to fill between.

In a case where the raster line is formed in the normal process, in the raster line, half dots are formed by the first head 42A and the remaining half dots are formed by the second head 42B. In other words, a usage rate of each head when the raster line is formed is 50% for the first head 42A, and also 50% for the second head 42B.

Since the dots are formed in region A by pass 1 to pass 6 and the dots are formed in region B by pass 2 to pass 7, the passes are shifted by one between region A and region B. Although the nozzles which are associated with each raster line are common to each region in order to shift the passes by one, the positions of the dots (scanning direction positions) which are formed by each nozzle are different for the odd-numbered pixels and the even-numbered pixels. For example, nozzle #8B of pass 2 forms the dots on the odd-numbered pixels with respect to the first raster line, but nozzle #8B of pass 3 forms the dots on the even-numbered pixels with respect to the tenth raster line.

Here, although not illustrated here, the 19th to 27th raster lines which are positioned more on the upstream side than region B in the transport direction form dots in substantially the same manner as in region A using pass 3 to pass 8. For example, the 19th raster line is associated with nozzle #8B, nozzle #10A, and nozzle #1A, and nozzle #8B forms dots on the odd-numbered pixels of the 19th raster line. In addition, the 28th to 36th raster lines which are positioned more on the upstream side than the 19th to 27th raster lines in the transport direction form dots in substantially the same manner as in region B using pass 4 to pass 9. In this manner, when continuously performing the normal process, dot formation is repeatedly performed in the same manner in region A and region B.

Furthermore, in the upper end section of the paper sheet 10, an upper end process is performed by micro-feeding the paper sheet 10. In the lower end section of the paper sheet 10, a lower end process is performed by micro-feeding the paper sheet 10. Here, explanation is omitted since the upper end process and the lower end process are well-known technologies.

### Color Unevenness Correction

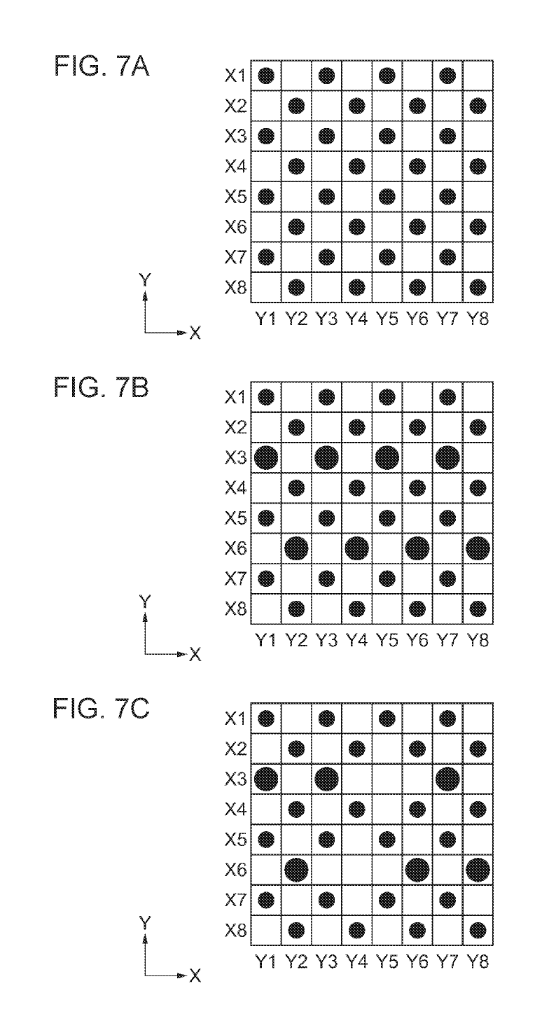

FIGS. 7A to 7C are schematic diagrams illustrating a state of dots which are formed in single color printing. In detail, FIG. 7A is a schematic diagram illustrating a state of dots which are ideally formed in single color printing. FIG. 7B is a schematic diagram illustrating a state of dots which are formed in single color printing prior to correction. FIG. 7C is a schematic diagram illustrating a state of dots which are formed in single color printing after correction.

In order to simplify the description, the dots are formed in 64 pixels which are disposed in a matrix of 8 rows by 8 rows. Furthermore, row numbers (X1 to X8) of the pixels which are arranged in the scanning direction (X direction) are given on the left side in FIGS. 7A to 7C. Row numbers (Y1 to Y8) of the pixels which are arranged in the transport direction (Y direction) are given on the lower side in FIGS. 7A to 7C.

Hereinafter in the description, the pixels which are arranged along row number Xn are referred to as pixel row Xn, and the pixels which are arranged along row number Ym are referred to as pixel row Ym. Pixels of a portion which intersects with pixel row Xn and pixel row Ym are referred to as (Xn, Ym) pixels. Here, the raster line described above is configured by dots which are provided in pixels which configure the pixel row Xn.

Furthermore, one dot is formed in one pixel, and a proportion of the number of pixels in which the dots are formed with respect to the entire number of pixels are referred to as a dot generation rate. For example, in FIG. 7A, the entire number of pixels is 64, and since the number of pixels in which the dot is formed is 32, the dot generation rate is 50%.

Hereinafter, a generation cause and correction process of the color unevenness (concentration unevenness) which is generated in the image on which single-color printing is carried out will be described with reference to FIGS. 7A to 7C. Here, in the case of multi-color printing, the generation cause of the same color unevenness (concentration unevenness) as in single-color printing is generated in each color, and the correction process of the same color unevenness (concentration unevenness) as in single-color printing is performed in each color.

As shown in FIG. 7A, under ideal conditions, the dot is formed in each pixel. Under ideal conditions, the process dimension of the nozzles are the same (uniform), the ink droplets of the same ink droplet weight are discharged from the respective nozzles centered on the respective pixel, and the dot is formed with the same size in each pixel. Since the size of the dots is the same (uniform), an image is formed with a constant concentration with no color unevenness (concentration unevenness). That is, the image is formed with a constant concentration corresponds to a dot generation rate of 50%.

Here, in practice, the process dimensions of the nozzles are not the same (uniform), and vary within a range. For this reason, when the process dimensions of the nozzles vary greatly, since the liquid droplet weight of the ink which is discharged from the nozzles varies greatly, it is difficult to form dots with the same size. For this reason, as shown in FIG. 7B, for example, when the liquid droplet weight of the ink which is discharged to a pixel row X3 and pixel row X6 is larger than the liquid droplet weight of the ink which is discharged to another pixel row Xn, the dots which are formed in pixel row X3 and pixel row X6 are larger than the dots formed in the other pixel row Xn. For this reason, a color of an image segment which is formed in pixel row X3 and pixel row X6 is more concentrated than the color of the image segment which is formed in the other pixel row Xn.

For example, when the dots which are formed in pixel row X3 and pixel row X6 are smaller than the dots which are formed in the other pixel row Xn, the color of the image segments which are formed in pixel row X3 and pixel row X6 are lighter than the color of the image segments which are formed in the other pixel row Xn.

Accordingly, the process dimensions of the nozzles vary greatly, the difference in the concentration of the color of the image segments which are formed in pixel row X3 and pixel row X6 and the concentration of the color of the image segments which are formed in the other pixel row Xn is large, and concentration unevenness (color unevenness) is generated.

For this reason, as shown in FIG. 7C, the correction process is performed such that the concentration of the color of the image segments which are formed in image row X3 and image row X6 is substantially equal to the concentration of the color of the image segments which are formed in the other pixel row Xn. In detail, the discharge state of the ink in the head 41 is controlled (corrected) such that the color of the image segments which are formed in the pixel row X3 is lightened, and such that the dots are not formed in the pixels (X3, Y5) in the pixel row X3. Furthermore, the discharge state of the ink in the head 41 is controlled (corrected) such that the color of the image segments which are formed in pixel row X6 is lightened, and such that the dots are not formed in the pixels (X6, Y4) in pixel row X6. As a result, it is possible to make the color of an image segment which is formed in pixel row X3 and pixel row X6 substantially equal to the color of the image segment which is formed in the other pixel row Xn, and suppress concentration unevenness (color unevenness).

In this manner, in the embodiment, the dot generation rate for pixel row Xn is corrected (adjusted), and concentration unevenness (color unevenness) is suppressed. In other words, the correction process is performed in which a gradation value of printing data for pixel row Xn is corrected, and concentration unevenness (color unevenness) is suppressed.

### Color Unevenness Correction Value Acquiring Process (Process on Printer Manufacturing Plant Side)

In the embodiment, in a manufacturing plant of the printer 100, a color unevenness correction value for suppressing color unevenness in the image described above is acquired for each printer 100 machine. In detail, in an inspection process at the manufacturing plant of the printer 100, a test pattern is printed in the printer 100, the test pattern is read by a colorimeter or a scanner, and the color unevenness correction values which correspond to each pixel row are acquired based on the concentration in the test pattern in each pixel row. Furthermore, the color unevenness correction value is stored (registered) in the memory 63 of the printer 100.

That is, at the printer 100 manufacturing plant side, each machine is evaluated for printability of the printer 100, and the color unevenness correction value is registered in each printer 100 machine such that the dot formation state of each nozzle is corrected (adjusted) at the user side.

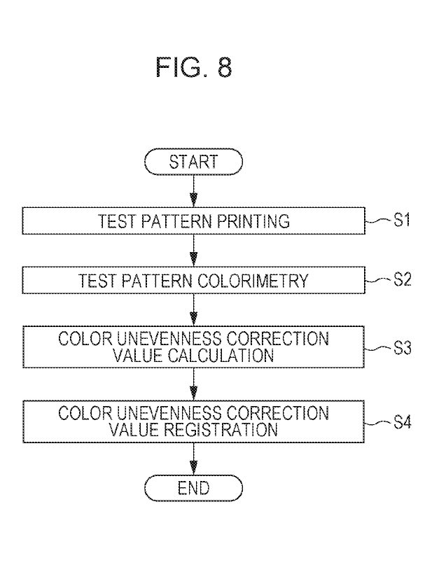

FIG. 8 is a flow chart of a process in which the color unevenness correction value is acquired which is performed at the manufacturing plant side of the printer.

As shown in FIG. 8, the process in which the color unevenness correction value is acquired includes a process (step S1) in which test pattern printing is carried out, a process (step S2) in which colorimetry is carried out on the test pattern, a process (step S3) is which the color unevenness correction value is calculated, and a process (step S4) in which the color unevenness correction value is registered in the printer 100.

In the manufacturing plant of the printer 100, a computer for acquiring (calculating) the color unevenness correction value (hereinafter referred to as a correction value acquiring computer), and the colorimeter or the scanner which acquires (carries out colorimetry on) color information of the test pattern are prepared. The colorimeter or the scanner are connected to the correction value acquiring computer in advance. When the printer 100 is manufactured at the manufacturing plant, the printer 100 is connected to the correction value acquiring computer, and step S1 to step S4 which are described above are executed.

In step S1, test pattern printing data is transmitted from the correction value acquiring computer to the printer 100. Here, the test pattern printing data is stored in advance in a memory of the correction value acquiring computer. The printer 100 which receives the test pattern printing data prints the test pattern on the paper sheet 10.

Here, step S1 is an example of a “pattern printing process”.

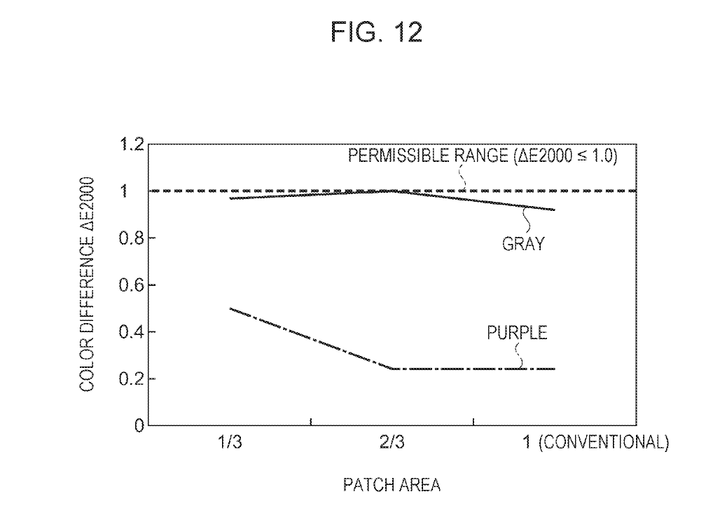

In step S2, a measurer carries out colorimetry on the printed test pattern using the colorimeter or the scanner. A plurality of patches are formed (printed) on the test pattern (refer to FIG. 12). The correction value acquiring computer acquires (carries out colorimetry on) color information on each patch from the colorimeter or the scanner.

Here, the plurality of patches which configure the test pattern are an example of a “plurality of patterns”. The plurality of patches (test patterns) which are printed on the paper sheet 10 will be described later in detail.

In step S3, the correction value acquiring computer calculates the color unevenness correction value by comparing reference color data which is stored (registered) in advance in the memory and a colorimetry result (color information). That is, the color unevenness correction value is calculated based on the information (color information) which is obtained from the plurality of patches.

Here, step S2 and step S3 are each examples of a “correction value calculation process”.

In step S4, the correction value acquiring computer writes the color unevenness correction value to the memory 63 of the printer 100. The printer 100 is shipped from the plant in a state in which the color unevenness correction value is registered (stored) in the memory 63.

Here, the color unevenness correction value is acquired by carrying out colorimetry on the test pattern, but is not limited thereto. For example, the color unevenness correction value may be acquired by directly measuring the amount of ink of discharged ink droplets.

### Process During Printing (User Side Process)

At the user side, the dot discharge state of each nozzle is corrected (adjusted) based on the color unevenness correction value which is acquired at the printer 100 manufacturing plant side, and color unevenness of the image which is printed on the paper sheet 10 is suppressed.

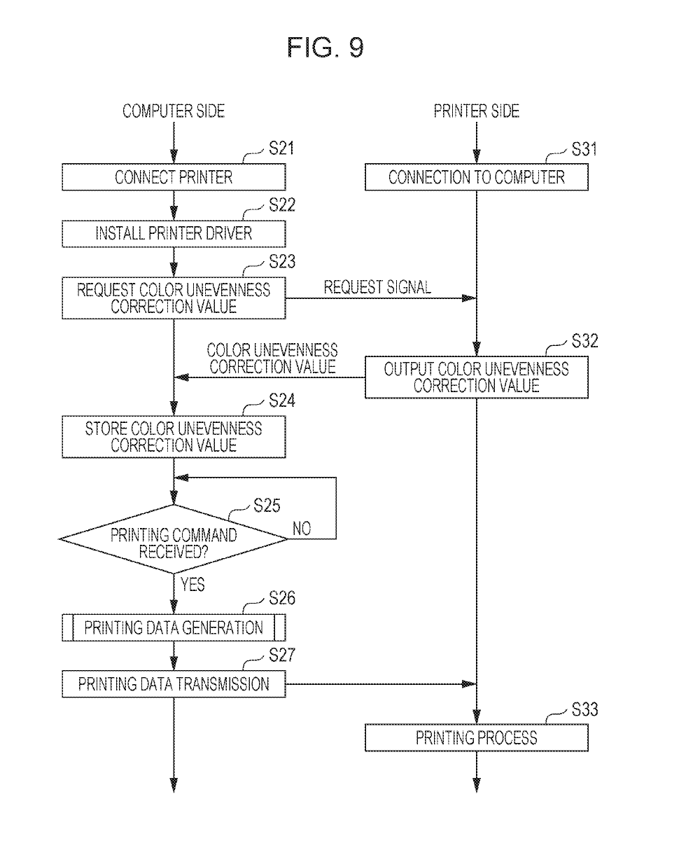

FIG. 9 is a flow chart of a process during printing which is performed at the user side.

As shown in FIG. 9, a user who purchases the printer 100 connects the printer 100 to the PC 110 (a separate computer to the correction value acquiring computer of the manufacturing plant of the printer 100) (steps S21 and S31).

Next, the user sets a CD-ROM which came with the PC 110, and installs a printer driver (step S22). The printer driver which is installed on the PC 110 requests transmission of the color unevenness correction value with respect to the printer 100 to the PC 110 (step S23). The printer 100 transmits the color unevenness correction value which is stored in the memory 63 to the PC 110 according to the request (step S32). The printer driver stores the color unevenness correction value which is sent from the printer 100 in the memory of the PC 110 (step S24). Thereby, a correction value table is created at the PC 110 side. After the processes up to this point are completed, the printer driver comes to be in a standby state until there is a printing command from the user (NO in step S25).

When the printer driver receives the printing command from the user (YES step S25), the printing data is generated based on the correction value table (step S26), and the printing data is transmitted to the printer 100 (step S27). The printer 100 performs the printing process according to the printing data (step S33).

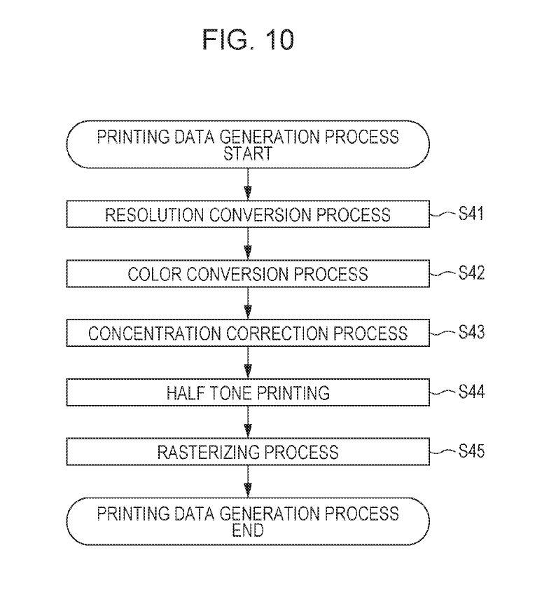

FIG. 10 is a block view of a printing data generation process which is performed by the printer driver.

As shown in FIG. 10, the printer driver initially performs resolution conversion processing (step S41). The resolution conversion processing is a process in which the image data which is output from an application program (text data, image data, and the like) is converted to a resolution of when printing on paper. For example, in a case where the printing resolution is designated as 1440×720 dpi, image data of a vector format which is received from the application is converted to image data with a resolution of 1440×720 dpi. Data of each pixel of the image data after the resolution conversion process is data which illustrates a gradation value of 256 gradation of an RGB color space.

Next, the printer driver performs color conversion processing (step S42). The color conversion processing is a process in which the RGB color space data is converted to color space data which corresponds to printer ink. The color conversion processing is performed by the printer driver referring a table in which the gradation value of the RGB data and the gradation value of CMYK data is associated. According to the color conversion processing, the RGB data in each pixel is converted to data of the color space which corresponds to the ink color. The image data after color conversion processing, is data which indicates the gradation value of the 256 gradation which is represented by a color space of eight dimensions C, M, Y, K, LC, LM, LK, and LLK.

Next, the printer driver performs a color unevenness correction process (concentration correction process) based on the correction value table (step S43). The color unevenness correction process (concentration correction process) is a process in which the gradation value of each pixel is corrected based on the concentration value which corresponds to the pixel row to which the pixel data belongs.

According to the color unevenness correction process, the gradation value of the pixel data which corresponds to the image row (data of the color space which corresponds to the ink color) is corrected so as to be reduced with respect to the image row in which darkness is easy to visually recognize. Alternatively, the gradation value of pixel data which corresponds to the pixel row is corrected so as to be increased with respect to the image row in which lightness is easy to visually recognize. Here, even with respect to other pixel rows of other colors, the printer driver performs the correction process in the same manner.

Next, the printer driver performs half tone processing (step S44). The half tone processing is a process in which the pixel data of the 256 gradation is converted to pixel data of four gradation that is a gradation number which the printer is able to form. The pixel data of four gradation after the half tone processing is data which indicates a size of the dot which is formed in a corresponding pixel. In detail, the pixel data is data in which any of large dots, medium dots, small dots, and no dots is indicated.

As a result, ink of eight colors of cyan (C), magenta (M), yellow (Y), black (K), light cyan (LC), light magenta (LM), light black (LK), and very light black (LLK) are discharged from the head 41 (first nozzle group 41A and second nozzle group 41B) with three types of sizes of dots (large dots, medium dots, and small dots).

In the half tone processing, the pixel data is generated such that it is possible for the printer 100 to form dots which are dispersed using a dither method, γ correction, an error diffusion method, or the like. When the half tone processing is performed, the printer driver refers to a dither table in a case where the dither method is performed, refers to a gamma table in a case where γ correction is performed, and refers to an error memory for storing the diffused error in a case where the error diffusion method is performed. The data which undergoes half tone processing has the same resolution (for example, 1440×720 dpi) as the RGB data described above.

In the embodiment, the half tone processing is performed with respect to the pixel data of the gradation value which is corrected by the color unevenness correction process. As a result, in the pixel row in which darkness is easy to visually recognize, the gradation value of the pixel data of the pixel row is corrected so as to be reduced, and the dot generation rate of the dots which are formed in the pixel row is reduced. In contrast, in the pixel row in which lightness is easy to visually recognize, the gradation value of the pixel data of the pixel row is corrected so as to be increased, and the dot generation rate of the dots which are formed in the pixel row is increased.

Finally, the printer driver performs a rasterizing process (step S45). The rasterizing process is a process in which the image data in a matrix form is modified in order in which data is to be transferred to the printer 100.

As described above, the printer driver generates printing data, and transmits the printing data to the printer 100. The printer 100 performs the printing process according to the printing data. In detail, the printer driver generates the printing data by adding command data to pixel data which is subjected to rasterizing, and transmits the printing data to the printer 100. The printer 100 controls each unit according to the command data within the printing data, and forms dots on the pixels of the paper sheet 10 by discharging ink from each nozzle according to the pixel data within the printing data, and prints the image in which color unevenness is suppressed.

### Known Technology Test Pattern

As described above, in step S1 (refer to FIG. 8), the printer 100 alternately repeats the liquid droplet discharge operation using the head 41 and the transport operation using the transport roller 23 based on the test pattern printing data which is transmitted from the correction value acquiring computer, and prints the test pattern on the paper sheet 10. The test pattern has a plurality of patches, the colorimeter or the scanner carry out colorimetry on each patch, and the colorimetry result (colorimetry information) of each patch is transmitted to the correction value acquiring computer.

For example, when the transport roller 23 is biased, and a distance between a center of rotation of the transport roller 23 and the outer periphery of the transport roller 23 varies, a portion in which transport speed is fast and a portion in which the transport speed is slow are generated within a range of the amount of transport in which the transport roller 23 rotates once (range of one circumference length of the transport roller 23). In the portion in which transport speed is fast, a light color image is printed on the paper sheet 10 in comparison with the portion in which transport speed is slow. In the portion in which transport speed is slow, a dark color image is printed on the paper sheet 10 in comparison with the portion in which transport speed is fast. That is, when the transport roller 23 is biased, shade unevenness is generated in the image which is printed on the paper sheet 10 within the range of one circumference length of the transport roller 23.

For this reason, in a known technology, the patch of one circumference length of the transport roller 23 is printed on the paper sheet 10. That is, a patch is printed which is formed of a portion which is printed in a light color and a portion which is printed in a dark color, the colorimetry result of the patch of the portion which is printed in a light color and the colorimetry result of the patch of the portion which is printed in a dark color are averaged, and the color unevenness correction value is calculated.

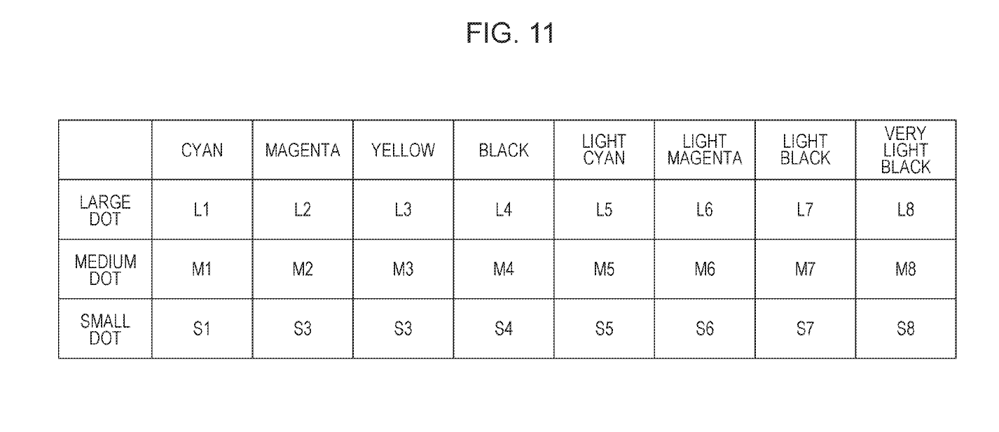

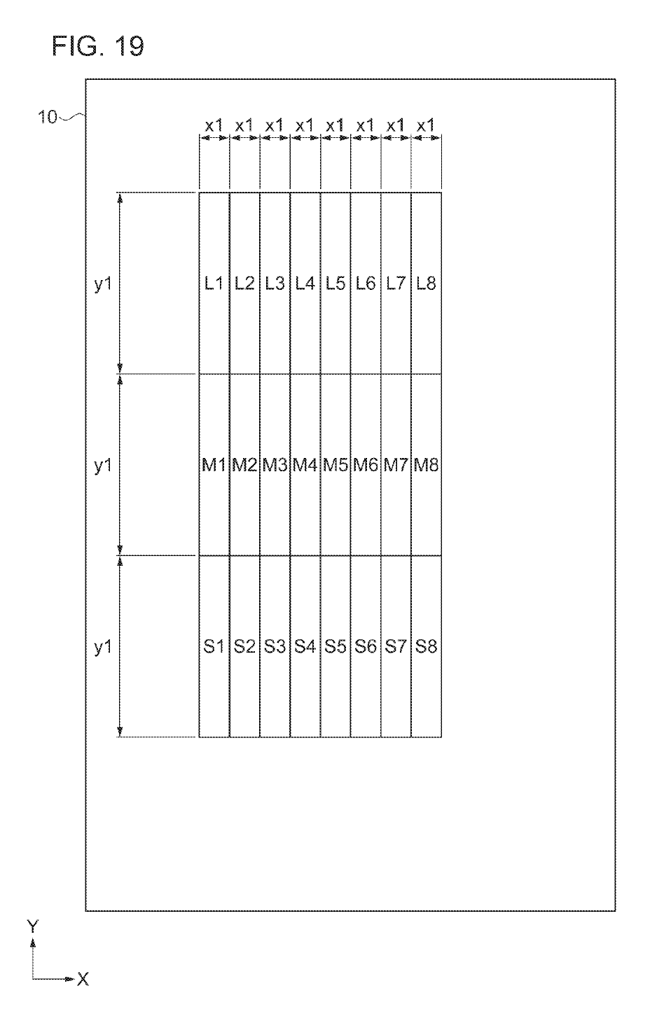

FIG. 19 is a schematic diagram of a test pattern according to known technologies. FIG. 11 is a table illustrating formation conditions of a patch which is a test pattern according to known technologies and a test pattern according to the embodiment.

As shown in FIG. 19, the test pattern of a known technology which is printed on the paper sheet 10 includes a plurality of patches of L1 to L8, M1 to M8, and S1 to S8 (24 types of patches). The plurality of patches of L1 to L8, M1 to M8, and S1 to S8 each have the same shape (area). A dimension y1 of the patch L1 in the Y direction is one circumference length of the transport roller 23 (amount of transport of one rotation of the transport roller 23). In a case where, for example, colorimetry is carried out by the colorimeter, a dimension x1 of the patch L1 in the X direction is set so as to be contained within a colorimetry range of the colorimeter. The patch L1 has a rectangular shape which is long in the transport direction (Y direction). The other patches L2 to L8, M1 to M8, and S1 to S8 also each have the same shape as the patch L1.

As described above, the ink of eight colors of cyan (C), magenta (M), yellow (Y), black (K), light cyan (LC), light magenta (LM), light black (LK), and very light black (LLK) are discharged from the head 41 (first nozzle group 41A and second nozzle group 41B) with three types of sizes of dots (large dots, medium dots, and small dots).

As shown in FIG. 11, the patch L1 is configured by a cyan large dot, the patch L2 is configured by a magenta large dot, the patch L3 is configured by a yellow large dot, the patch L4 is configured by a black large dot, the patch L5 is configured by a light cyan large dot, the patch L6 is configured by a light magenta large dot, the patch L7 is configured by a light black large dot, and the patch L8 is configured by a very light black large dot. Furthermore, the patch M1 is configured by a cyan medium dot, the patch M2 is configured by a magenta medium dot, the patch M3 is configured by a yellow medium dot, the patch M4 is configured by a black medium dot, the patch M5 is configured by a light cyan medium dot, the patch M6 is configured by a light magenta medium dot, the patch M7 is configured by a light black medium dot, and the patch M8 is configured by a very light black medium dot. Furthermore, the patch S1 is configured by a cyan small dot, the patch S2 is configured by a magenta small dot, the patch S3 is configured by a yellow small dot, the patch S4 is configured by a black small dot, the patch S5 is configured by a light cyan small dot, the patch S6 is configured by a light magenta small dot, the patch S7 is configured by a light black small dot, and the patch S8 is configured by a very light black small dot.

In FIG. 19, the patch L1 is a pattern for carrying out colorimetry on an image which is formed using a cyan large dot, the patch L2 is a pattern for carrying out colorimetry on an image which is formed using a magenta large dot, the patch L3 is a pattern for carrying out colorimetry on an image which is formed using a yellow large dot, the patch L4 is a pattern for carrying out colorimetry on an image which is formed using a black large dot, the patch L5 is a pattern for carrying out colorimetry on an image which is formed using a light cyan large dot, the patch L6 is a pattern for carrying out colorimetry on an image which is formed using a light magenta large dot, the patch L7 is a pattern for carrying out colorimetry on an image which is formed using a light black large dot, and the patch L8 is a pattern for carrying out colorimetry on an image which is formed using a very light black large dot.

The patch M1 is a pattern for carrying out colorimetry on an image which is formed using a cyan medium dot, the patch M2 is a pattern for carrying out colorimetry on an image which is formed using a magenta medium dot, the patch M3 is a pattern for carrying out colorimetry on an image which is formed using a yellow medium dot, the patch M4 is a pattern for carrying out colorimetry on an image which is formed using a black medium dot, the patch M5 is a pattern for carrying out colorimetry on an image which is formed using a light cyan medium dot, the patch M6 is a pattern for carrying out colorimetry on an image which is formed using a light magenta medium dot, the patch M7 is a pattern for carrying out colorimetry on an image which is formed using a light black medium dot, and the patch M8 is a pattern for carrying out colorimetry on an image which is formed using a very light black medium dot.

The patch S1 is a pattern for carrying out colorimetry on an image which is formed using a cyan small dot, the patch S2 is a pattern for carrying out colorimetry on an image which is formed using a magenta small dot, the patch S3 is a pattern for carrying out colorimetry on an image which is formed using a yellow small dot, the patch S4 is a pattern for carrying out colorimetry on an image which is formed using a black small dot, the patch S5 is a pattern for carrying out colorimetry on an image which is formed using a light cyan small dot, the patch S6 is a pattern for carrying out colorimetry on an image which is formed using a light magenta small dot, the patch S7 is a pattern for carrying out colorimetry on an image which is formed using a light black small dot, and the patch S8 is a pattern for carrying out colorimetry on an image which is formed using a very light black small dot.

The patches L1 to L8, M1 to M8, and S1 to S8 are each formed by discharging ink droplets from the head 41 (first nozzle group 41A and second nozzle group 41B).

Although illustration is omitted, the test pattern has a patch which is formed of dots of two different colors. For example, a patch of a purple color which is configured by a dot which is formed of cyan and a dot which is formed of magenta, a patch of a green color which is configured by a dot which is formed of yellow and a dot which is formed of cyan, and the like. Furthermore, the test pattern has a patch which is formed by only the first nozzle group 41A, a patch which is formed by only the second nozzle group 41B, and the like. Furthermore, the test pattern has a patch which is formed by changing the dot generation rate.

In order to acquire a more appropriate color unevenness correction value (in order to increase quality of the printed image), a large number of patches which configure the test pattern is preferable, and the number of processes for printing the test pattern, and the number of processes for carrying out colorimetry on the test pattern are increased. Furthermore, when the transport roller 23 is increased in size in order to make the printing speed of the image faster, the dimension y1 of the patches L1 to L8, M1 to M8, and S1 to S8 in the Y direction increases, that is, the area of the patches L1 to L8, M1 to M8, and S1 to S8 increases, and the number of processes for printing the test pattern, and the number of processes for carrying out colorimetry on the test pattern are further increased. In this manner, in order to increase the quality of the printed image, and to make the printing speed of the image faster, in the known technologies of test patterns, there is a problem in that the number of processes for printing the test pattern, and the number of processes for carrying out colorimetry on the test pattern are further increased, and the work effectiveness is worsened. Additionally, there is also a problem that the amount of consumption of ink for printing the test pattern is further increased.

### Test Pattern of Embodiment

FIG. 12 is a graph illustrating a relationship of color difference of printed images and a patch area for acquiring color information. In detail, FIG. 12 is a graph illustrating acquiring (calculating) the color unevenness correction value from the color information of the patch in which the area is changed within a range of ⅓ to 1, and a relationship of color difference of printed images and the patch area based on printing data which is corrected using the color unevenness correction value.

The horizontal axis in FIG. 12 is the patch area which configures the test pattern. In FIG. 12, in a case where the area of the patch is the same as in a known technology, the patch area is one (conventional). In a case in which the patch has an area of ⅓ in comparison to a known technology, the patch area is ⅓. In a case in which the patch has an area of ⅔ in comparison to a known technology, the patch area is ⅔. In the embodiment, the patch area is set to three conditions of ⅓, ⅔, and 1. Here, a dimension x1 in the X direction is constant, and the patch area is changed by changing a dimension y1 in the Y direction.

The vertical axis in FIG. 12 is a color difference Δ E2000.

A broken line in FIG. 12 indicates the permissible range of the color difference Δ E2000. In the embodiment, a case where the color difference Δ E2000 is one or less is set as OK (good), and a case where the color difference Δ E2000 is larger than one is set as NG (not good). Here, a case where the color difference Δ E2000 is one or less is to the extent to which it is possible to sense a slight color difference by visual determination, and corresponds to color difference in which there is no practical problem.

Furthermore, in the embodiment, the color difference Δ E2000 is evaluated with respect to an image which is printed in gray and purple. Here, gray is an example of a color in which it is easiest for a person to sense a change by eye. Purple is an example of a color in which is more difficult for a person to sense a change by eye compared to gray.

The inventor examines a relationship of color difference of printed images and a patch area for acquiring color information. As a result, as shown in FIG. 12, the color difference Δ E2000 of an image which is printed according to the color unevenness correction value that is calculated from color information of the patch with an area ⅓ in comparison to known technologies is one or less, and the color difference Δ E2000 of an image which is printed according to the color unevenness correction value that is calculated from color information of the patch with an area ⅔ in comparison to known technologies is one or less. That is, even if the inventor reduces the patch area, the reality is discovered that it is possible to acquire the color unevenness correction value with equal precision to the patch in known technologies, and suppress color unevenness to an equal level as known technologies.

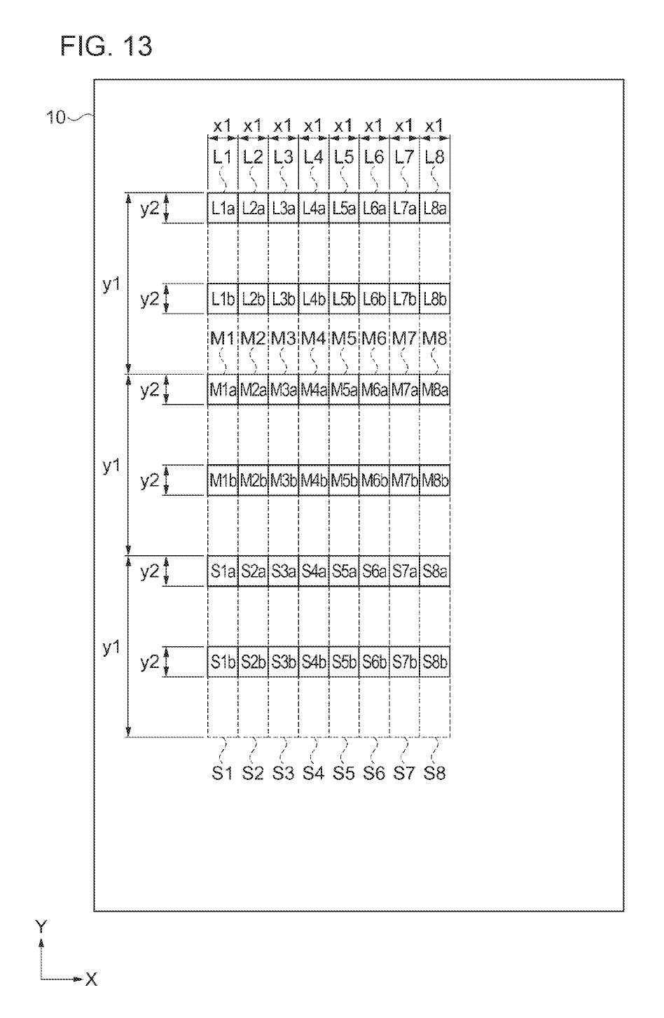

FIG. 13 is a schematic diagram of a test pattern according to the embodiment.

Hereinafter in the description, a region in which the known technology patch L1 is formed (printed) is referred to as a region L1, a region in which the known technology patch L2 is formed is referred to as a region L2, a region in which the known technology patch L3 is formed is referred to as a region L3, a region in which the known technology patch L4 is formed is referred to as a region L4, a region in which the known technology patch L5 is formed is referred to as a region L5, a region in which the known technology patch L6 is formed is referred to as a region L6, a region in which the known technology patch L7 is formed is referred to as a region L7, and a region in which the known technology patch L8 is formed is referred to as a region L8. The regions L1 to L8 are illustrated by broken lines in FIG. 13.

Furthermore, a region in which the known technology patch M1 is formed (printed) is referred to as a region M1, a region in which the known technology patch M2 is formed is referred to as a region M2, a region in which the known technology patch M3 is formed is referred to as a region M3, a region in which the known technology patch M4 is formed is referred to as a region M4, a region in which the known technology patch M5 is formed is referred to as a region M5, a region in which the known technology patch M6 is formed is referred to as a region M6, a region in which the known technology patch M7 is formed is referred to as a region M7, and a region in which the known technology patch M8 is formed is referred to as a region M8. The regions M1 to M8 are illustrated by broken lines in FIG. 13.

Furthermore, a region in which the known technology patch S1 is formed (printed) is referred to as a region S1, a region in which the known technology patch S2 is formed is referred to as a region S2, a region in which the known technology patch S3 is formed is referred to as a region S3, a region in which the known technology patch S4 is formed is referred to as a region S4, a region in which the known technology patch S5 is formed is referred to as a region S5, a region in which the known technology patch S6 is formed is referred to as a region S6, a region in which the known technology patch S7 is formed is referred to as a region S7, and a region in which the known technology patch S8 is formed is referred to as a region S8. The regions S1 to S8 are illustrated by broken lines in FIG. 13.

As shown in FIG. 13 in the test pattern according to the embodiment, a patch L1a and a patch L1b which are formed by a cyan large dot are printed in the region L1. A dimension y2 of the patches L1a and L1b in the Y direction is ⅙ of the Y direction dimension y1 of the known technology patch L1. A dimension of the patch L1a and the patch L1b in the X direction is x1 which is the same as the dimension of the known technology patch L1 in the X direction. Consequently, the area of the patches L1a and L1b is ⅙ of the area of the known technology patch L1. That is, in the embodiment, a patch which is ⅓ of the area in comparison to the known technology is formed by the patch L1a which is ⅙ of the area in comparison to the known technology and the patch L1b which is ⅙ of the area in comparison to the known technology. Since the patches which are ⅓ of the area in comparison to the known technology are subjected to colorimetry, it is possible to acquire the color unevenness correction value with equal precision to the known technology patch.

Furthermore, even in a case where there is a concern that shade unevenness is generated in the image within the range of the one circumference length of the transport roller 23 due to biasing of the transport roller 23, the patch which is ⅓ of the area in comparison to the known technology is not provided in one location, and since the patch is provided to be dispersed in the two locations of the patch L1a and the patch L1b, it is possible to reduce the influence of the shade unevenness and acquire a more appropriate color unevenness correction value.

In the same manner, a patch L2a and a patch L2b which are formed by a magenta large dot are printed in the region L2. A patch L3a and a patch L3b which are formed by a yellow large dot are printed in the region L3. A patch L4a and a patch L4b which are formed by a black large dot are printed in the region L4. A patch L5a and a patch L5b which are formed by a light cyan large dot are printed in the region L5. A patch L6a and a patch L6b which are formed by a light magenta large dot are printed in the region L6. A patch L7a and a patch L7b which are formed by a light black large dot are printed in the region L7. A patch L8a and a patch L8b which are formed by a very light black large dot are printed in the region L8.

Furthermore, a patch M1a and a patch M1b which are formed by a cyan medium dot are printed in the region M1, a patch M2a and a patch M2b which are formed by a magenta medium dot are printed in the region M2, a patch M3a and a patch M3b which are formed by a yellow medium dot are printed in the region M3, a patch M4a and a patch M4b which are formed by a black medium dot are printed in the region M4, a patch M5a and a patch M5b which are formed by a light cyan medium dot are printed in the region M5, a patch M6a and a patch M6b which are formed by a light magenta medium dot are printed in the region M6, a patch M7a and a patch M7b which are formed by a light black medium dot are printed in the region M7, and a patch M8a and a patch M8b which are formed by a very light black medium dot are printed in the region M8.

Furthermore, a patch S1a and a patch S1b which are formed by a cyan small dot are printed in the region S1, a patch S2a and a patch S2b which are formed by a magenta small dot are printed in the region S2, a patch S3a and a patch S3b which are formed by a yellow small dot are printed in the region S3, a patch S4a and a patch S4b which are formed by a black small dot are printed in the region S4, a patch S5a and a patch S5b which are formed by a light cyan small dot are printed in the region S5, a patch S6a and a patch S6b which are formed by a light magenta small dot are printed in the region S6, a patch S7a and a patch S7b which are formed by a light black small dot are printed in the region S7, and a patch S8a and a patch S8b which are formed by a very light black small dot are printed in the region S8.

In other words, in the embodiment, a plurality of patches are printed on the paper sheet 10 in the transport direction within a range of one circumference length of the transport roller 23 by the head 41 (first nozzle group 41A and second nozzle group 41B). That is, the patch L1a and the patch L1b, the patch L2a and the patch L2b, the patch L3a and the patch L3b, the patch L4a and the patch L4b, the patch L5a and the patch L5b, the patch L6a and the patch L6b, the patch L7a and the patch L7b, the patch L8a and the patch L8b, the patch M1a and the patch M1b, the patch M2a and the patch M2b, the patch M3a and the patch M3b, the patch M4a and the patch M4b, the patch M5a and the patch M5b, the patch M6a and the patch M6b, the patch M7a and the patch M7b, the patch M8a and the patch M8b, the patch S1a and the patch S1b, the patch S2a and the patch S2b, the patch S3a and the patch S3b, the patch S4a and the patch S4b, the patch S5a and the patch S5b, the patch S6a and the patch S6b, the patch S7a and the patch S7b, and the patch S8a and the patch S8b, are printed on the paper sheet 10 in the transport direction within a range of one circumference length of the transport roller 23. Furthermore, the color unevenness correction value is acquired (calculated) based on the color information which is obtained by carrying out colorimetry on the plurality of patches which are printed within the range of one circumference length of the transport roller 23, and information which relates to discharge of ink droplets from the head 41 (first nozzle group 41A and the second nozzle group 41B) is corrected. That is, the information which relates to discharge of ink droplets from the head 41 is corrected such that the color unevenness of the image which is printed on the paper sheet 10 is reduced.

In the embodiment, since the area of the patches which configure the test pattern is reduced to ⅓ in comparison to the known technology, it is possible to reduce the number of processes for printing the test pattern (patches) and the number of processes for carrying out colorimetry on the test pattern (patches) to approximately ⅓. That is, it is possible to increase workability of the printing and colorimetry of the test pattern using the test pattern of the embodiment. Furthermore, in the embodiment, since an amount of consumption of ink for printing the test pattern is reduced to approximately ⅓ in comparison to the known technology, it is possible to reduce costs for printing the test pattern.

### Test Pattern Modification Example 1

Next, a modification example of the test pattern will be described.

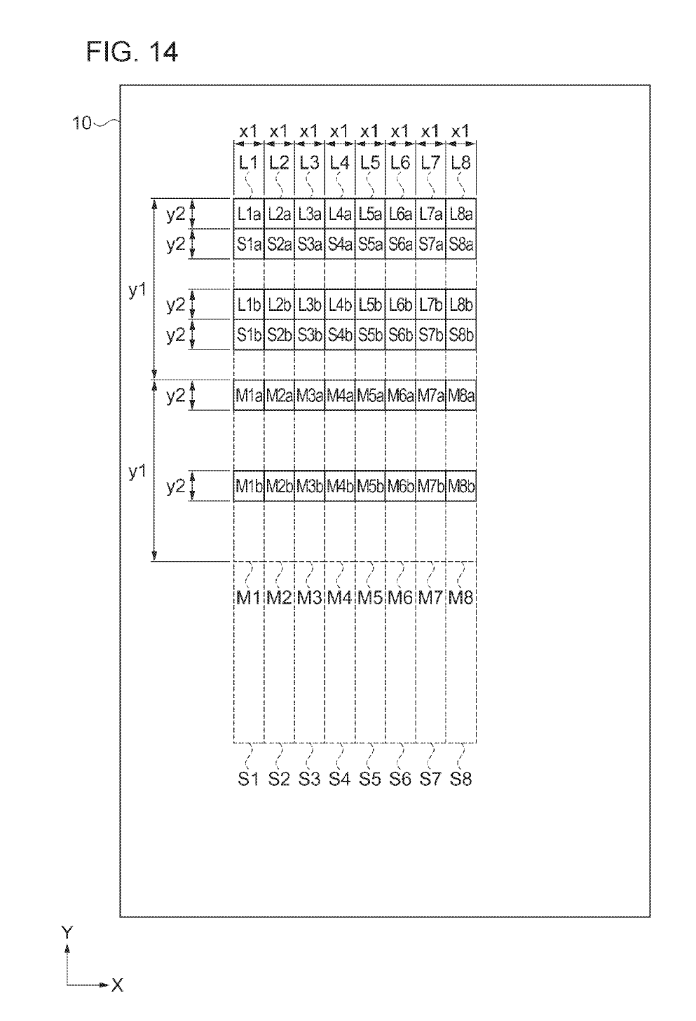

FIG. 14 is a diagram which corresponds to FIG. 13, and is a schematic diagram of a test pattern according to Modification Example 1. In FIG. 14 the regions L1 to L8, the regions M1 to M8, and the regions S1 to S8 are illustrated using broken lines.

As shown in FIG. 14, in the test pattern of the modification example, in addition to the patch L1a and the patch L1b, the patch S1a and the patch S1b are formed in the region L1. In detail, the patch L1a, the patch S1a, the patch L1b, and the patch S1b are formed in the region L1 in order along the Y (−)direction. Here, in the test pattern of Embodiment 1, the patch L1a and the patch L1b are formed in the region L1 (refer to FIG. 13). In this point, the test pattern of the modification example and the test pattern of Embodiment 1 are different.

In other words, the test pattern of the embodiment has a plurality of patches which are printed on the paper sheet 10 in the transport direction within a range of one circumference length of the transport roller 23 by the head 41 (first nozzle group 41A and second nozzle group 41B). The plurality of patches which are printed within the range of one circumference length of the transport roller 23 has a plurality of first patches (patch L1a and patch L1b), and a plurality of second patches (patch S1a and patch S1b) which have information that is different from the plurality of first patches. That is, in the region L1, the patch L1a and the path L1b are an example of the “plurality of first patterns”. The patch S1a and the patch S1b are an example of the “plurality of second patterns which have information that is different from the plurality of first patterns”.

Furthermore, the patch L1a and the patch L1b which are an example of the first pattern are formed by a cyan large dot, and the patch S1a and the patch S1b which are an example of the second pattern are formed by a cyan small dot. In other words, there is a configuration in which the size (ink droplet weight) of the liquid droplets (ink droplets) which are discharged from the head 41 are different for the patch L1a and the patch L1b which are an example of the first pattern, and the patch S1a and the patch S1b which are an example of the second pattern.

Furthermore, in addition to the patch L2a and the patch L2b, the patch S2a and the patch S2b are formed in the region L2. In addition to the patch L3a and the patch L3b, the patch S3a and the patch S3b are formed in the region L3. In addition to the patch L4a and the patch L4b, the patch S4a and the patch S4b are formed in the region L4. In addition to the patch L5a and the patch L5b, the patch S5a and the patch S5b are formed in the region L5. In addition to the patch L6a and the patch L6b, the patch S6a and the patch S6b are formed in the region L6. In addition to the patch L7a and the patch L7b, the patch S7a and the patch S7b are formed in the region L7. In addition to the patch L8a and the patch L8b, the patch S8a and the patch S8b are formed in the region L8.

In the region L2, the patch L2a and the patch L2b are an example of the “plurality of first patterns”, and the patch S2a and the patch S2b are an example of the “plurality of second patterns”. In the region L3, the patch L3a and the patch L3b are an example of the “plurality of first patterns”, and the patch S3a and the patch S3b are an example of the “plurality of second patterns”. In the region L4, the patch L4a and the patch L4b are an example of the “plurality of first patterns”, and the patch S4a and the patch S4b are an example of the “plurality of second patterns”. In the region L5, the patch L5a and the patch L5b are an example of the “plurality of first patterns”, and the patch S5a and the patch S5b are an example of the “plurality of second patterns”. In the region L6, the patch L6a and the patch L6b are an example of the “plurality of first patterns”, and the patch S6a and the patch S6b are an example of the “plurality of second patterns”. In the region L7, the patch L7a and the patch L7b are an example of the “plurality of first patterns”, and the patch S7a and the patch S7b are an example of the “plurality of second patterns”. In the region L8, the patch L8a and the patch L8b are an example of the “plurality of first patterns”, and the patch S8a and the patch S8b are an example of the “plurality of second patterns”.

Here, patches which are the same as the test pattern of Embodiment 1 which is illustrated in FIG. 13 are formed in the regions M1 to M8. There are no patches formed in the regions S1 to S8.

In this manner, the plurality of patches are formed (printed) in the regions L1 to L8 and the regions M1 to M8, and are not formed (printed) in the regions S1 to S8. Consequently, in the embodiment, it is possible to further reduce the area of a portion in which the plurality of patches are printed in comparison to Embodiment 1. Furthermore, other patches, for example, patches which are formed by dots of two different colors, patches which are only formed by the first nozzle group 41A, patches which are only formed by the second nozzle group 41B, patches which are formed by changing the dot generation rate, and the like are printed in the portion in which the patches are not printed, and it is possible to form more patches in the test pattern in comparison to Embodiment 1. Accordingly, it is possible to form more patches in the test pattern, acquire a more appropriate color unevenness correction value, and further increase the quality of the printed image.

### Test Pattern Modification Example 2

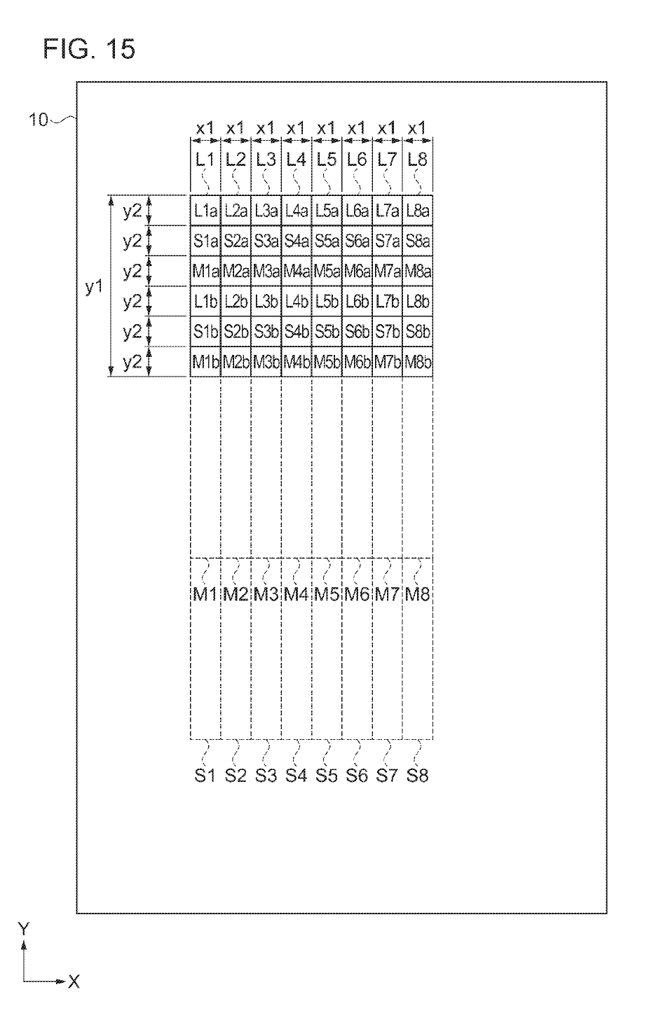

FIG. 15 is a diagram which corresponds to FIG. 13, and is a schematic diagram of a test pattern according to Modification Example 2. In FIG. 15 the regions L1 to L8, the regions M1 to M8, and the regions S1 to S8 are illustrated using broken lines.

As shown in FIG. 15, in the test pattern of the modification example, in addition to the patch L1a and the patch L1b, the patch S1a and the patch S1b, and the patch M1a and the patch M1b are formed in the region L1. In detail, the patch L1a, the patch S1a, the patch M1a, the patch L1b, the patch S1b, and the patch M1b are formed in the region L1 in order along the Y (−)direction. Here, in the test pattern of Embodiment 1, the patch L1a and the patch L1b are formed in the region L1 (refer to FIG. 13). In this point, the test pattern of the modification example and the test pattern of Embodiment 1 are different.

In other words, the test pattern of the embodiment has a plurality of patches which are printed on the paper sheet 10 in the transport direction within a range of one circumference length of the transport roller 23 by the head 41 (first nozzle group 41A and second nozzle group 41B). The plurality of patches which are printed within the range of one circumference length of the transport roller 23 has a plurality of first patches (patch L1a and patch L1b), and a plurality of second patches (patch S1a and patch S1b, and patch M1a and patch M1b) which have information that is different from the plurality of first patches. That is, in the region L1, the patch L1a and the path L1b are an example of the “plurality of first patterns”. The patch S1a and the patch S1b, and the patch M1a and the patch M1b are an example of the “plurality of second patterns which have information that is different from the plurality of first patterns”.

Furthermore, the patch L1a and the patch L1b which are an example of the first pattern are formed by a cyan large dot, the patch S1a and the patch S1b which are an example of the second pattern are formed by a cyan small dot, and the patch M1a and the patch M1b which are an example of the second pattern are configured by a cyan medium dot. In other words, there is a configuration in which the size (ink droplet weight) of the liquid droplets (ink droplets) which are discharged from the head 41 are different for the patch L1a and the patch L1b which are an example of the first pattern, the patch S1a and the patch S1b which are an example of the second pattern, and the patch M1a and the patch M1b which are an example of the second pattern.

Furthermore, in addition to the patch L2a and the patch L2b, the patch S2a and the patch S2b, and the patch M2a and the patch M2b are formed in the region L2. In addition to the patch L3a and the patch L3b, the patch S3a and the patch S3b, and the patch M3a and the patch M3b are formed in the region L3. In addition to the patch L4a and the patch L4b, the patch S4a and the patch S4b, and the patch M4a and the patch M4b are formed in the region L4. In addition to the patch L5a and the patch L5b, the patch S5a and the patch S5b, and the patch M5a and the patch M5b are formed in the region L5. In addition to the patch L6a and the patch L6b, the patch S6a and the patch S6b, and the patch M6a and the patch M6b are formed in the region L6. In addition to the patch L7a and the patch L7b, the patch S7a and the patch S7b, and the patch M7a and the patch M7b are formed in the region L7. In addition to the patch L8a and the patch L8b, the patch S8a and the patch S8b, and the patch M8a and the patch M8b are formed in the region L8.

In the region L2, the patch L2a and the patch L2b are an example of the “plurality of first patterns”, and the patch S2a and the patch S2b, and the patch M2a and the patch M2b are an example of the “plurality of second patterns”. In the region L3, the patch L3a and the patch L3b are an example of the “plurality of first patterns”, and the patch S3a and the patch S3b, and the patch M3a and the patch M3b are an example of the “plurality of second patterns”. In the region L4, the patch L4a and the patch L4b are an example of the “plurality of first patterns”, and the patch S4a and the patch S4b, and the patch M4a and the patch M4b are an example of the “plurality of second patterns”. In the region L5, the patch L5a and the patch L5b are an example of the “plurality of first patterns”, and the patch S5a and the patch S5b, and the patch M5a and the patch M5b are an example of the “plurality of second patterns”. In the region L6, the patch L6a and the patch L6b are an example of the “plurality of first patterns”, and the patch S6a and the patch S6b, and the patch M6a and the patch M6b are an example of the “plurality of second patterns”. In the region L7, the patch L7a and the patch L7b are an example of the “plurality of first patterns”, and the patch S7a and the patch S7b, and the patch M7a and the patch M7b are an example of the “plurality of second patterns”. In the region L8, the patch L8a and the patch L8b are an example of the “plurality of first patterns”, and the patch S8a and the patch S8b, and the patch M8a and the patch M8b are an example of the “plurality of second patterns”.

Here, no patches are formed in the regions M1 to M8 and the regions S1 to S8.

In this manner, the plurality of patches are formed (printed) in the regions L1 to L8 and are not formed (printed) in the regions M1 to M8 and the regions S1 to S8. Consequently, in the embodiment, it is possible to further reduce the area of a portion in which the plurality of patches are printed in comparison to Embodiment 1. Furthermore, other patches, for example, patches which are formed by dots of two different colors, patches which are only formed by the first nozzle group 41A, patches which are only formed by the second nozzle group 41B, patches which are formed by changing the dot generation rate, and the like are printed in the portion in which the patches are not printed, and it is possible to form more patches in the test pattern in comparison to Embodiment 1. Accordingly, it is possible to form more patches in the test pattern, acquire a more appropriate color unevenness correction value, and further increase the quality of the printed image.

### Test Pattern Modification Example 3

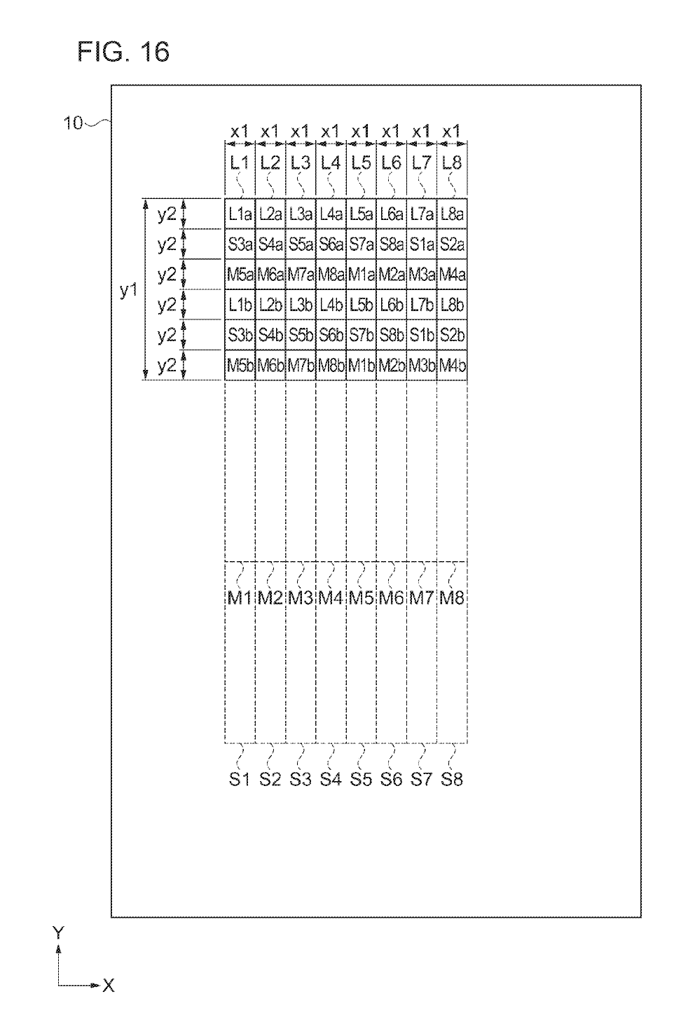

FIG. 16 is a diagram which corresponds to FIG. 13, and is a schematic diagram of a test pattern according to Modification Example 3. In FIG. 16 the regions L1 to L8, the regions M1 to M8, and the regions S1 to S8 are illustrated using broken lines.

As shown in FIG. 16, in the test pattern of the modification example, in addition to the patch L1a and the patch L1b, the patch S3a and the patch S3b, and the patch M5a and the patch M5b are formed in the region L1. In detail, the patch L1a, the patch S3a, the patch M5a, the patch L1b, the patch S3b, and the patch M5b are formed in the region L1 in order along the Y (−)direction. Here, in the test pattern of Embodiment 1, the patch L1a and the patch L1b are formed in the region L1 (refer to FIG. 13). In this point, the test pattern of the modification example and the test pattern of Embodiment 1 are different.

In other words, the test pattern of the embodiment has a plurality of patches which are printed on the paper sheet 10 in the transport direction within a range of one circumference length of the transport roller 23 by the head 41 (first nozzle group 41A and second nozzle group 41B). The plurality of patches which are printed within the range of one circumference length of the transport roller 23 has a plurality of first patches (patch L1a and patch L1b), and a plurality of second patches (patch S3a and patch S3b, and patch M5a and patch M5b) which have information that is different from the plurality of first patches. That is, in the region L1, the patch L1a and the path L1b are an example of the “plurality of first patterns”. The patch S3a and the patch S3b, and the patch M5a and the patch M5b are an example of the “plurality of second patterns which have information that is different from the plurality of first patterns”.

Furthermore, the patch L1a and the patch L1b which are an example of the first pattern are formed by a cyan large dot, the patch S3a and the patch S3b which are an example of the second pattern are formed by a yellow small dot, and the patch M5a and the patch M5b which are an example of the second pattern are configured by a light cyan medium dot. In other words, there is a configuration in which the color of the patch S3a and the patch S3b which are an example of the second pattern, and the color of the patch M5a and the patch M5b which are an example of the second pattern are different from the color of the patch L1a and the patch L1b which are an example of the first pattern.

Furthermore, in addition to the patch L2a and the patch L2b, the patch S4a and the patch S4b, and the patch M6a and the patch M6b are formed in the region L2. In addition to the patch L3a and the patch L3b, the patch S5a and the patch S5b, and the patch M7a and the patch M7b are formed in the region L3. In addition to the patch L4a and the patch L4b, the patch S6a and the patch S6b, and the patch M8a and the patch M8b are formed in the region L4. In addition to the patch L5a and the patch L5b, the patch S7a and the patch S7b, and the patch M1a and the patch M1b are formed in the region L5. In addition to the patch L6a and the patch L6b, the patch S8a and the patch S8b, and the patch M2a and the patch M2b are formed in the region L6. In addition to the patch L7a and the patch L7b, the patch S1a and the patch S1b, and the patch M3a and the patch M3b are formed in the region L7. In addition to the patch L8a and the patch L8b, the patch S2a and the patch S2b, and the patch M4a and the patch M4b are formed in the region L8.

In the region L2, the patch L2a and the patch L2b are an example of the “plurality of first patterns”, and the patch S4a and the patch S4b, and the patch M6a and the patch M6b are an example of the “plurality of second patterns”. In the region L3, the patch L3a and the patch L3b are an example of the “plurality of first patterns”, and the patch S5a and the patch S5b, and the patch M7a and the patch M7b are an example of the “plurality of second patterns”. In the region L4, the patch L4a and the patch L4b are an example of the “plurality of first patterns”, and the patch S6a and the patch S6b, and the patch M8a and the patch M8b are an example of the “plurality of second patterns”. In the region L5, the patch L5a and the patch L5b are an example of the “plurality of first patterns”, and the patch S7a and the patch S7b, and the patch M1a and the patch M1b are an example of the “plurality of second patterns”. In the region L6, the patch L6a and the patch L6b are an example of the “plurality of first patterns”, and the patch S8a and the patch S8b, and the patch M2a and the patch M2b are an example of the “plurality of second patterns”. In the region L7, the patch L7a and the patch L7b are an example of the “plurality of first patterns”, and the patch S1a and the patch S1b, and the patch M3a and the patch M3b are an example of the “plurality of second patterns”. In the region L8, the patch L8a and the patch L8b are an example of the “plurality of first patterns”, and the patch S2a and the patch S2b, and the patch M4a and the patch M4b are an example of the “plurality of second patterns”.

Here, no patches are formed in the regions M1 to M8 and the regions S1 to S8.

In this manner, the plurality of patches are formed (printed) in the regions L1 to L8 and are not formed (printed) in the regions M1 to M8 and the regions S1 to S8. Consequently, in the embodiment, it is possible to further reduce the area of a portion in which the plurality of patches are printed in comparison to Embodiment 1. Furthermore, other patches, for example, patches which are formed by dots of two different colors, patches which are only formed by the first nozzle group 41A, patches which are only formed by the second nozzle group 41B, patches which are formed by changing the dot generation rate, and the like are printed in the portion in which the patches are not printed, and it is possible to form more patches in the test pattern in comparison to Embodiment 1. Accordingly, it is possible to form more patches in the test pattern, acquire a more appropriate color unevenness correction value, and further increase the quality of the printed image.

Here, in order to print the image at a higher speed, for example, when the transport roller becomes bigger, it is necessary for the length of the amount of transport of one rotation of the transport roller to become bigger, to print bigger colorimetry patterns, and to carry out colorimetry on the respective bigger colorimetry patterns. For this reason, there is a problem in that workability is further worsened in order to calculate the concentration unevenness correction value in comparison to a case in which the length of the amount of transport of one rotation of the transport roller is reduced.

In contrast to this, the area of the pattern is reduced, the number of times the pattern is printed and the number of times colorimetry (reading) is carried out on the correction pattern are reduced, and the workability for obtaining the information which corrects the discharge of the liquid droplets is improved in comparison to a case in which the pattern of one circumference length of the transport roller is printed by printing the plurality of patterns within the range of one circumference length of the transport roller. Accordingly, in a case where more patterns are formed in order to print a higher quality image, or a case where the size of the transport roller is increased in order to print the image at a higher speed, there is an effect in that it is possible to suppress worsening of the workability for obtaining information which corrects the discharge of the liquid droplets in comparison to a case where the pattern of one circumference length of the transport roller is printed.

### Embodiment 2

### Printing System Summary

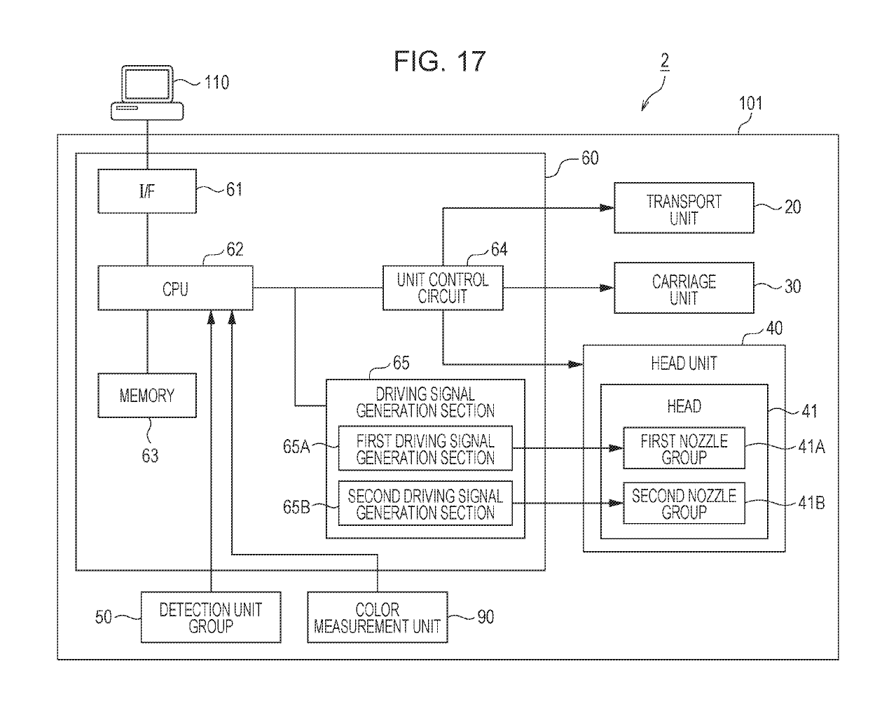

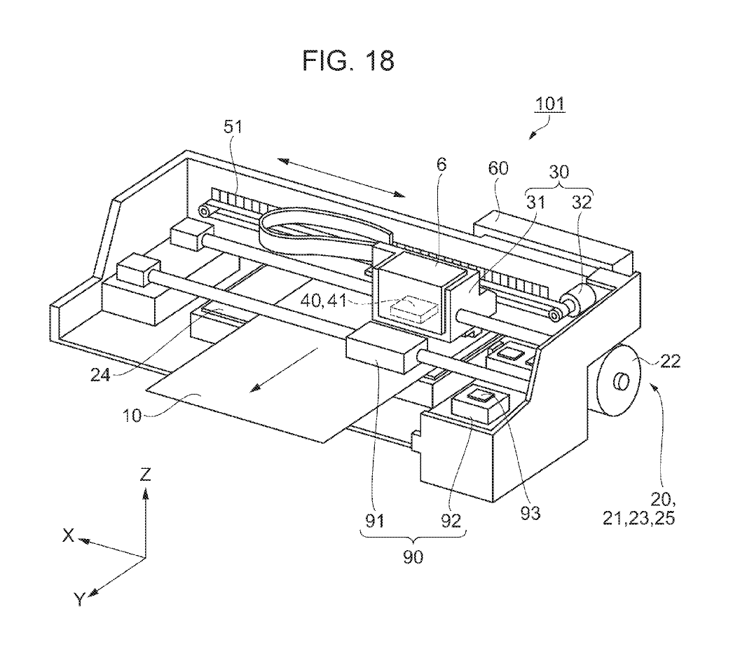

FIG. 17 is a block diagram illustrating the entire configuration of a printing system according to Embodiment 2. FIG. 18 is a schematic view illustrating the entire configuration of a printer according to the embodiment.

As shown in FIG. 17, in a printing system 2 according to the embodiment, a printer 101 has a color measurement unit 90, prints and carries out colorimetry on a test pattern using the printer 101, and acquire the color unevenness correction value. Meanwhile, in Embodiment 1, in a manufacturing plant of the printer, colorimetry is carried out using a colorimeter or scanner which is separate from the printer 100, and acquires the color unevenness correction value. In this point, the printing system 2 according to the embodiment and the printing system 1 according to Embodiment 1 are different, and the other configuration is the same in the embodiment and Embodiment 1.

The printing system 2 according to the embodiment will be described below focusing on differences from the printing system 1 according to Embodiment 1 with reference to FIGS. 17 and 18. In addition, the same reference numerals are given for the configuration parts which are the same as in Embodiment 1, and overlapping description is omitted.

As shown in FIG. 17, the printing system 2 is configured by a printer 101 and a PC 110.

The PC 110 is communicably connected to the printer 101, and printing data according to an image is output to the printer 100. A computer program such as an application program and a printer driver is installed in the PC 110.

The printer 101 has the color measurement unit 90 which is an example of “reading means”.

A program for performing a process (refer to FIG. 8) in which the color unevenness correction value is acquired is installed on a printer driver of the PC 110 and the controller 60 of the printer 101.

As shown in FIG. 18, the color measurement unit 90 has a colorimeter 91 and a calibration section 92. The colorimeter 91 is provided on the downstream side of the carriage unit 30 in the transport direction. That is, it is possible to carry out colorimetry on the test pattern which is printed by the carriage unit 30 using the colorimeter 91.

Although illustration is omitted, the colorimeter 91 has a transport motor, and is able to reciprocally move (scan) in the scanning direction (X direction). Furthermore, the colorimeter 91 has light emitting section (omitted from the drawings), a light receiving section (omitted from the drawings), and a lens (omitted from the drawings). The light emitting section is, for example, configured by an ultraviolet light-emitting diode, tungsten lamp, or the like. The light receiving section is, for example, configured by a photodiode or the like. The lens is an optical component for condensing light which is emitted by the light emitting section and radiating the light onto the test pattern, and condensing the reflected light of the test pattern and causing the reflected light to be incident onto the light receiving section.

The calibration section 92 is provided on the X (−) direction side with respect to the colorimeter 91. The calibration section 92 has a white tile 93. The white tile 93 is a tile made of ceramics for executing calibration of the colorimeter 91 when colorimetry is not carried out.

The colorimeter 91 reads a reference (white color of the white tile 93), the appropriateness of the value is confirmed, and in a case where the value to is deviated, the value of the reference is adjusted so as to be output. The adjustment work is referred to as calibration, and the colorimeter 91 carries out colorimetry on the test pattern after calibration is performed.

The printing system 2 performs a process in which the color unevenness correction value is acquired that includes a process for printing the test pattern (step S1), a process for carrying out colorimetry on the test pattern (step S2), a process for calculating the color unevenness correction value (step S3), and a process for registering the color unevenness correction value (step S4) (refer to FIG. 8).

In step S1, the test pattern printing data is transmitted from the PC 110 to the printer 101. Here, the test pattern printing data is stored in advance in a memory of the PC 110. The printer 101 which receives the test pattern printing data prints the test pattern on the paper sheet 10.

In step S2, colorimetry is carried out on the printed test pattern by the color measurement unit 90. In detail, the color measurement unit 90 carries out colorimetry on the color information based on a lab color mode which defines the color value using white balance, chromaticity, and brightness from the test pattern.

In step S3, the controller 60 calculates the color unevenness correction value by comparing reference color data which is stored (registered) in advance in the memory 63 and a colorimetry result. That is, the color unevenness correction value is calculated by converting the color information based on the lab color mode which is measured by the color measurement unit 90 to a CMYK color mode.

In step S4 the color unevenness correction value which is calculated by the controller 60 is written (registered) in the memory of the PC 110.

When the printer driver receives a printing command from the user, the printer driver performs the printing data generation process illustrated in FIG. 10, controls the discharge state of the ink droplets from the head 41 (first nozzle group 41A and second nozzle group 41B) such that the color of the image data is faithfully reproduced, and the color unevenness is suppressed.

Also in a case where, for example, the head 41 (first nozzle group 41A and second nozzle group 41B) is changed over time due to the printer 101 having the color measurement unit 90, printing and carrying out colorimetry on a test pattern using the printer 101, and acquiring the color unevenness correction value, it is possible to update to a more appropriate color unevenness correction value, and control (correct) the discharge state of the ink droplets from the head 41 so as to faithfully reproduce the color of the image data. That is, even in a case where the head 41 (first nozzle group 41A and second nozzle group 41B) is changed over time, it is possible to maintain (update) to a more appropriate color unevenness correction value so as to more appropriately suppress color unevenness.

The present application is not limited to the embodiments described above, and is able to be appropriately modified within a range that does not depart from the gist or spirit of the invention which is read from the claims and the entire specification, and a printing apparatus accompanying such a modification and the printing system which includes the printing apparatus are included within the technical range of the present application.

Embodiments other than those described above are considered to be various modification examples. The given modification examples are described below.

### Modification Example 4

The printing apparatus of the present application is not limited to the printing apparatus which is able to carry out multi-color printing described above, and for example, may be a printing apparatus which is able to carry out monochrome printing (black and white printing). That is, it is possible to suppress shade unevenness of an image which is formed using black (K) ink by applying the present application to the printing apparatus which is able to carry out monochrome printing (black and white printing).

### Modification Example 5

The printing system 2 (printer 101) according to Embodiment 2 may have a scanner in place of the color measurement unit 90. That is, the printing system 2 may have a configuration in which colorimetry is carried out on the test pattern that is printed on the printer 101 using the scanner, and the color unevenness correction value is acquired.

Furthermore, the printing system 2 may have a configuration in which the scanner is built in to the printer 101, and may have a configuration in which the printer 101 is provided separately.

### Modification Example 6

In the test pattern according to Embodiment 1, the range of one circumference length of the transport roller 23 (the regions L1 to L8, the regions M1 to M8, and the regions S1 to S8) is split into six, and two patches are formed (printed) in the region divided into six (refer to FIG. 13). Furthermore, in the test pattern according to Modification Example 1, the range of one circumference length of the transport roller 23 (the regions L1 to L8, the regions M1 to M8, and the regions S1 to S8) is split into six, and four patches are formed (printed) in the region divided into six (refer to FIG. 14). Furthermore, in the test pattern according to Modification Example 2 and the test pattern according to Modification Example 3, the range of one circumference length of the transport roller 23 (the regions L1 to L8, the regions M1 to M8, and the regions S1 to S8) is split into six, and six patches are formed (printed) in the region divided into six (refer to FIGS. 15 and 16).

Here, the number of splits in the range of one circumference length of the transport roller 23 is not limited to six, and may be more than six splits, for example, seven splits or eight splits. Furthermore, the number of splits in the range of one circumference length of the transport roller 23 may be less than six splits, for example, five splits or four splits.

That is, it is sufficient to have a configuration in which a plurality of patches are formed (printed) with respect to the region which is split into more than six, or the region which is split into less than six, and the total area of the plurality of patches is ⅓ or more of the area of the patches of the known technology.

### Modification Example 7

It is possible, for example, to acquire the color unevenness correction value with equal precision to the known technology patch even if the area of the patch is smaller than ⅓ of the area of the known technology patch by increasing process precision of the transport roller 23, precision of the transport motor 22, uniformity of the ink droplets which are discharged from the head 41, and the like. Consequently, in the configuration in which one circumference length of the transport roller 23 is split into a plurality of ranges, and the plurality patches are formed (printed) in the region which is split, the total area of the plurality of patches is not limited to ⅓ or more of the area of the patches of the known technology as long as it is possible to acquire the color unevenness correction value with equal precision to the known technology. That is, as long as it is possible to acquire the color unevenness correction value with equal precision to the known technology, the total area of the plurality of patches may be smaller than ⅓ of the area of the known technology patches.

This application claims priority to Japanese Patent Application No. 2014-256997 filed on Dec. 19, 2014. The entire disclosure of Japanese Patent Application No. 2014-256997 is hereby incorporated herein by reference.

What is claimed is:

1. A printing apparatus comprising:
a transport roller which transports a medium;
a head which is able to discharge liquid droplets; and
a control section which controls the transport roller and the head,
wherein a plurality of patterns are printed using the head in a transport direction of the medium within a range of one circumference length of the transport roller, and
information which relates to discharge of the liquid droplets is corrected based on information which is obtained from the plurality of patterns.

2. The printing apparatus according to claim 1,
wherein the plurality of patterns include a plurality of first patterns, and a plurality of second patterns which have information that is different from the plurality of first patterns.

3. The printing apparatus according to claim 2,
wherein a color of the plurality of second patterns is different from a color of the plurality of first patterns.

4. The printing apparatus according to claim 2,
wherein a size of the liquid droplets which are discharged from the head is different in the plurality of first patterns and the plurality of second patterns.

5. The printing apparatus according to claim 1, further comprising:
a reading unit that is able to read the plurality of patterns.

6. A printing system comprising:
the printing apparatus according to claim 1; and
a computer which controls the printing apparatus.

7. A printing system comprising:
the printing apparatus according to claim 2; and
a computer which controls the printing apparatus.

8. A printing system comprising:
the printing apparatus according to claim 3; and
a computer which controls the printing apparatus.

9. A printing system comprising:
the printing apparatus according to claim 4; and
a computer which controls the printing apparatus.

10. A printing system comprising:
the printing apparatus according to claim 5; and
a computer which controls the printing apparatus.

11. A correction value calculation method of a printing apparatus including a transport roller that transports a medium and a head that is able to discharge liquid droplets, in which correction of discharge of the liquid droplets is carried out, the method comprising:
printing a plurality of patterns on the medium within a range of one circumference length of the transport roller in a transport direction of the medium; and
calculating a correction value based on information that is obtained from the plurality of patterns.
